(19) United States
(12) Patent Application Publication
(10) Pub. No.: US 2016/0370861 A1
(43) Pub. Date: Dec. 22, 2016

(54) INPUT DEVICE AND INPUT CONTROL METHOD

(71) Applicant: FUJITSU LIMITED, Kawasaki-shi (JP)

(72) Inventor: Katsuhiko IKEDA, Hino (JP)

(21) Appl. No.: 15/149,936

(22) Filed: May 9, 2016

(30) Foreign Application Priority Data
Jun. 16, 2015 (JP) 2015-121028

(51) Int. Cl. G06F 3/01; G06F 3/042; G06K 9/00

(52) U.S. Cl. CPC G06F 3/014; G06F 3/016; G06K 9/00355; G06F 3/0425

(57) ABSTRACT

An input device that inputs a command to an information processing device includes a member with which the input device is attached to a hand of a user, a light source configured to project light onto a finger of the user, an image capture device configured to capture an image of reflected light from the finger onto which the light is projected, and a processor configured to: acquire a plurality of images from the image capture device, specify a positional change in the finger based on a change in patterns of the reflected light specified from the respective images, generate the command corresponding to a movement of the finger, based on the positional change, and input the generated command to the information processing device.

### CROSS-REFERENCE TO RELATED APPLICATION

This application is based upon and claims the benefit of priority of the prior Japanese Patent Application No. 2015-121028, filed on Jun. 16, 2015, the entire contents of which are incorporated herein by reference.

### FIELD

The embodiment discussed herein is related to information input control.

### BACKGROUND

In a portable terminal such as a smartphone, a display and a touch panel are often mounted on top of each other. A user may operate such a terminal by touching regions where icons, a menu, and the like are displayed with his/her finger. In this event, the touch panel detects a region where input processing is performed by the user, the kind of an input operation, and the like. Then, the portable terminal performs processing associated with the operation detected by the touch panel.

A wearable terminal such as a head mounted display (HMD) and a watch-type device has recently attracted more and more attention. However, the wearable terminal is not equipped with a touch panel of a size easy to use by a user for input operations. This may complicate input processing. To address this, there has been proposed, as a related technique, a symbol generation device configured to generate a signal corresponding to a movement trajectory pattern of a mobile object such as a finger of a user. The symbol generation device uses a detection signal to specify a movement trajectory pattern of the mobile object, and specifies a signal corresponding to the specified movement trajectory pattern (for example, Japanese Laid-open Patent Publication No. 11-31047). Moreover, there has also been proposed an information input method in which ultrasonic speakers are mounted at both ends of wrists whereas ultrasonic microphones are worn on the respective finger tips, and the two-dimensional position of each finger tip from a time difference between when an ultrasonic wave is outputted from the corresponding ultrasonic speaker and when the ultrasonic wave is detected by the corresponding ultrasonic microphone (for example, Japanese Laid-open Patent Publication No. 2005-316763). In the information input method, acceleration sensors having sensitivity in a direction perpendicular to the palm are further mounted on the finger tips of the respective fingers, and movements of the fingers such as punching on a keyboard are recognized by detecting changes in accelerations outputted from the acceleration sensors. Furthermore, there has also been proposed an input device including a camera attached to a wrist so as to capture images of user's fingers, a sensor configured to recognize the tilt of the user's arm, and an information processing device (for example, Japanese Laid-open Patent Publication No. 2005-301583). The input device detects a punching operation based on the position of the user's hand detected by the sensor and the positions of the user's finger tips detected from an image captured by the camera.

### SUMMARY

According to an aspect of the invention, an input device that inputs a command to an information processing device includes a member with which the input device is attached to a hand of a user, a light source configured to project light onto a finger of the user, an image capture device configured to capture an image of reflected light from the finger onto which the light is projected, and a processor configured to: acquire a plurality of images from the image capture device, specify a positional change in the finger based on a change in patterns of the reflected light specified from the respective images, generate the command corresponding to a movement of the finger, based on the positional change, and input the generated command to the information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a sequence diagram illustrating an example of an input method according to an embodiment;

FIG. 2 is a diagram illustrating a configuration example of an input device;

FIG. 3 is a diagram illustrating a hardware configuration example of the input device;

FIG. 4 is a diagram illustrating an appearance example of the input device;

FIG. 5 is a diagram illustrating an example of an infrared light irradiation pattern;

FIG. 6 is a diagram illustrating an example of a method for calculating a change in distance;

FIG. 7 is a diagram illustrating an example of coordinates;

FIG. 8 is a diagram illustrating an example of a method for detecting positions of fingers;

FIG. 9 is a diagram illustrating an example of a method for detecting positions of fingers;

FIG. 10 is a diagram illustrating an example of an acceleration measurement result;

FIG. 11 is a diagram illustrating an example of input processing according to a first operation example;

FIG. 12 is a flowchart illustrating an example of the input processing according to the first operation example;

FIG. 13 is a diagram illustrating an example of input processing according to a second operation example;

FIG. 14 is a diagram illustrating an example of input processing according to the second operation example;

FIG. 15 is a flowchart illustrating an example of the input processing according to the second operation example;

FIG. 16A is a diagram illustrating an example of input processing according to a third operation example;

FIG. 16B is a diagram illustrating an example of input processing according to the third operation example;

FIG. 17 is a flowchart illustrating an example of the input processing according to the third operation example;

FIG. 18A is a diagram illustrating an example of input processing according to a fourth operation example;

FIG. 18B is a diagram illustrating an example of input processing according to the fourth operation example;

FIG. 19 is a flowchart illustrating an example of the input processing according to the fourth operation example;

FIG. 20 is a diagram illustrating an example of input processing according to a fifth operation example;

FIG. 21 is a diagram illustrating an example of input processing according to the fifth operation example;

FIG. 22 is a flowchart illustrating an example of the input processing according to the fifth operation example; and

FIG. 23 is a diagram illustrating an example of input processing according to a sixth operation example.

### DESCRIPTION OF EMBODIMENT

As described in the background, several techniques have been studied on the input devices for use to perform input to another device. However, the method using the ultrasonic speakers mounted at both ends of the wrists, the ultrasonic microphones worn on the finger tips, and the acceleration sensors attached to the palms is difficult for the user to use because of many parts to mount. Moreover, in the case of generating a signal from a trajectory pattern of a mobile object or in the case of using the input device used to detect the punching operation, it is difficult to determine each of many kinds of operations used for input to a touch panel. Therefore, an input result desired by the user may not be obtained.

It is an object of the technique disclosed in the embodiment to provide a highly convenient input device.

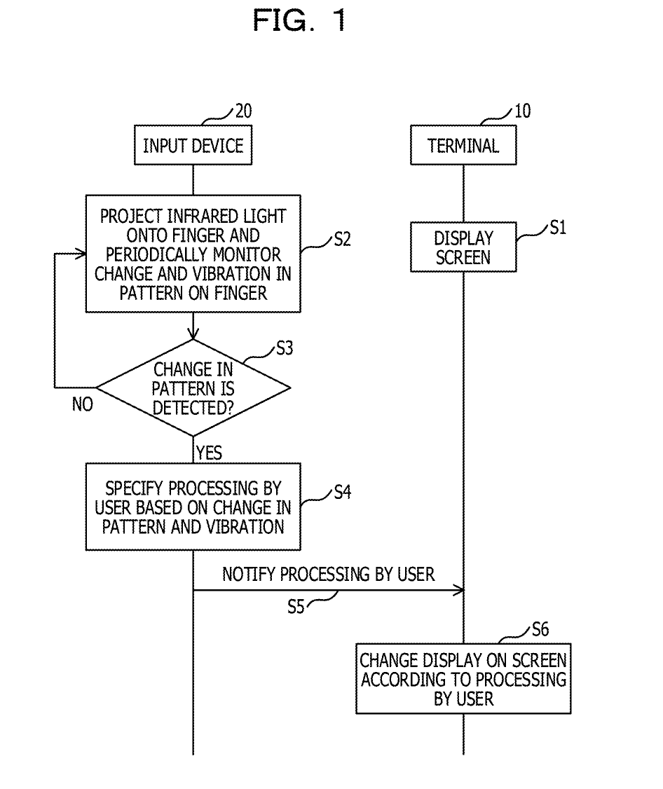

FIG. 1 is a sequence diagram illustrating an example of an input method according to an embodiment. FIG. 1 illustrates an example of processing performed between a terminal 10 and an input device 20. Note that the terminal 10 includes any information processing device capable of communicating with the input device 20, even other than a terminal that is difficult for a user to perform input processing on, such as a wearable terminal and a watch-type terminal. On the other hand, the input device 20 is a device capable of projecting an infrared light pattern, and includes an acceleration sensor for detecting vibration. The infrared light pattern is any pattern that enables a distance to an object irradiated with the pattern to be calculated based on changes in the pattern, such as a lattice pattern and a dotted pattern, for example.

In Step S1, the terminal 10 displays an image on a screen. The user of the terminal 10 wears the input device 20 such that the infrared light pattern outputted from the input device 20 is projected onto his/her finger. The input device 20 uses an infrared camera or the like to periodically monitor a pattern obtained from the reflection by the user's finger when the infrared light pattern is projected onto the finger. Furthermore, the input device 20 uses the acceleration sensor to also periodically monitor changes in vibration (Step S2).

The input device 20 determines whether or not a change in the infrared light pattern is detected (Step S3). The input device 20 repeats the processing of Steps S2 and S3 until a change in the infrared light pattern is detected (No in Step S3).

Meanwhile, for example, it is assumed that the user of the terminal 10 visually confirms the display on the screen of the terminal 10 and moves his/her finger to perform processing. In this case, the infrared light pattern projected onto the user's finger changes with a change in a distance between an infrared light irradiation position on the input device 20 and the user's finger tip. In such a case, since a change in the infrared light pattern is detected, the input device 20 specifies processing performed by the user from the change in the infrared light pattern and the vibration (Yes in Step S3, Step S4). Then, the input device 20 notifies the terminal 10 of contents specified as the processing performed by the user (Step S5). Upon receipt of the notification of the processing by the user from the input device 20, the terminal 10 changes the display on the screen according to the processing by the user (Step S6).

As described above, the input device 20 that projects the infrared light pattern usable to obtain a change in distance is used at the user's finger tip. Then, the trajectory of the user's finger is obtained without attaching many parts to the user's hand, fingers, and the like. In other words, the method according to the embodiment enables the processing by the user to be specified just by installing one input device 20 at the position where the infrared light may be projected onto the user's finger, the input device 20 including parts used for irradiation of the infrared light pattern, the infrared camera, and the acceleration sensor. Therefore, the input device 20 is easy for the user to wear and is highly convenient. Furthermore, the input device 20 specifies the movement of the user's finger, and thus has an advantage that the user easily performs the processing compared with the case where the user performs input processing by wearing a mobile object used for the processing. Moreover, there is also an advantage for a vendor that the input device 20 may be manufactured at a lower cost than a device used in a method using a number of parts.

<Device Configuration>

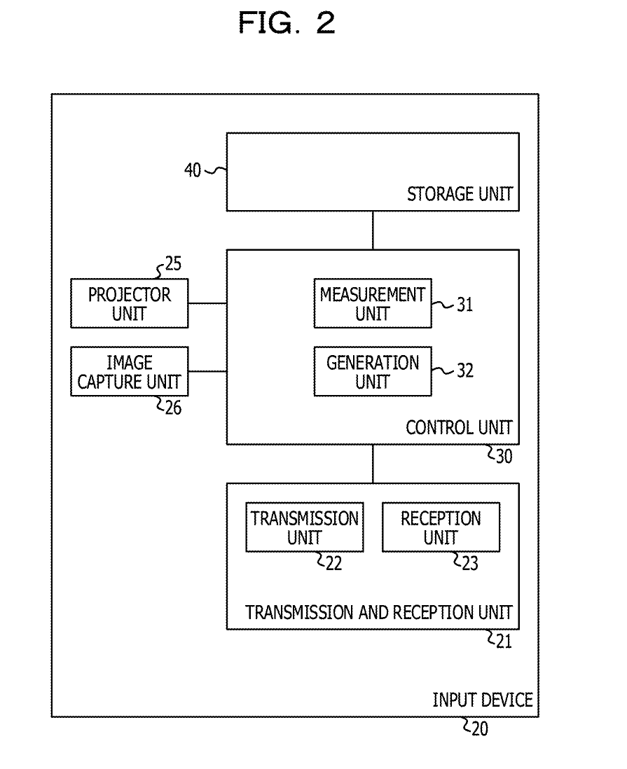

FIG. 2 is a diagram illustrating a configuration example of the input device 20. The input device 20 includes a transmission and reception unit 21, a projector unit 25, an image capture unit 26, a control unit 30, and a storage unit 40. The transmission and reception unit 21 includes a transmission unit 22 and a reception unit 23. The control unit 30 includes a measurement unit 31 and a generation unit 32.

The projector unit 25 projects an infrared light pattern. Note that the preferable infrared light pattern to be projected is one in which a change in the size and interval of a pattern depending on a distance to a target to be projected with infrared light is easily recognizable in an image captured by the image capture unit 26. The image capture unit 26 captures images of the pattern of the infrared light reflected from a target object irradiated with the infrared light pattern. The following description is given assuming that the infrared light pattern is projected onto user's finger.

The measurement unit 31 measures the magnitude of vibration of the user's finger. The generation unit 32 uses a change in the infrared light pattern captured by the image capture unit 26 to specify a positional change in the user's finger, and generates an input signal using the trajectory of the position of the user's finger. Moreover, the generation unit 32 uses the magnitude of the vibration obtained by the measurement unit 31 to specify the type of processing performed by the user. The storage unit 40 stores information to be used for processing by the control unit 30 and information obtained by the processing by the control unit 30. The transmission unit 22 transmits data such as the input signal generated by the generation unit 32 to the terminal 10. The reception unit 23 receives data from the terminal 10 as appropriate.

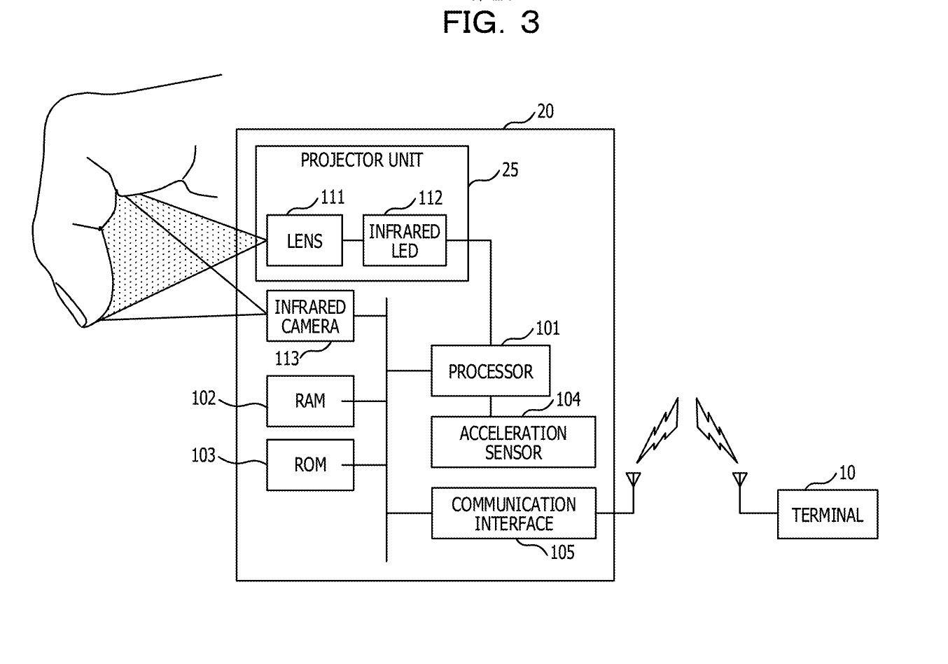

FIG. 3 is a diagram illustrating a hardware configuration example of the input device 20. The input device 20 includes a processor 101, a random access memory (RAM) 102, a read only memory (ROM) 103, an acceleration sensor 104, and a communication interface 105. The input device 20 further includes a lens 111, an infrared light emitting diode (LED) 112, and an infrared camera 113. The processor 101, the RAM 102, the ROM 103, the acceleration sensor 104, the communication interface 105, the infrared LED 112, and the infrared camera 113 are connected to each other so as to enable input and output of data to and from each other. Note that FIG. 3 illustrates an example of the hardware configuration of the input device 20, and changes may be made according to implementation. For example, the input device 20 may include a gyro sensor in addition to the acceleration sensor 104.

The processor 101 is an arbitrary processing circuit including a central processing unit (CPU). The processor 101 operates as the generation unit 32 by reading and executing a program stored in the ROM 103. The measurement unit 31 is realized by the processor 101 and the acceleration sensor 104. The lens 111 and the infrared LED 112 operate as the projector unit 25. The infrared camera 113 operates as the image capture unit 26. The communication interface 105 realizes the transmission and reception unit 21. The storage unit 40 is realized by the RAM 102 and the ROM 103.

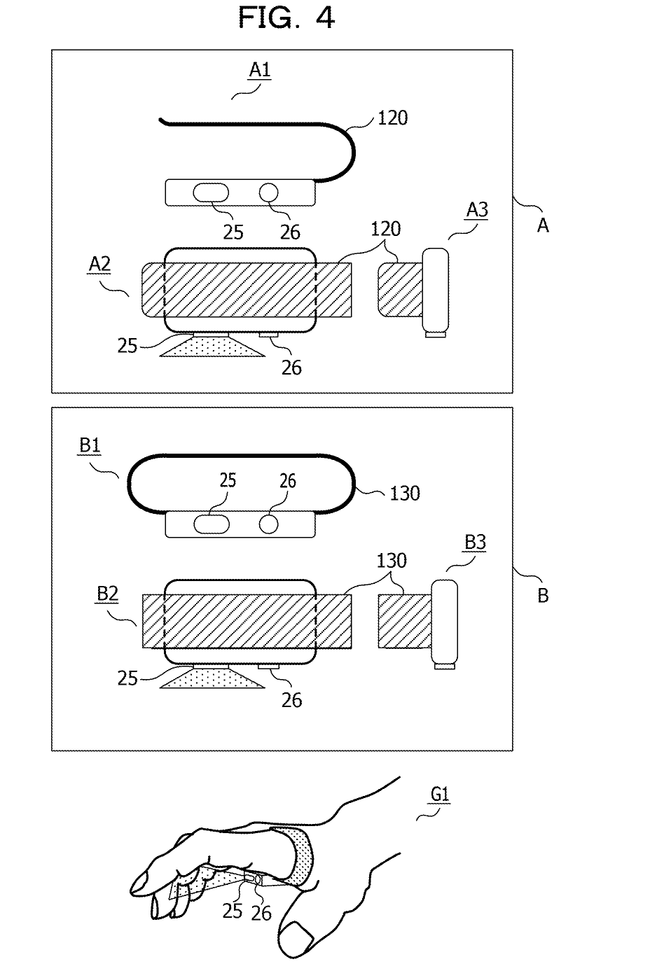

FIG. 4 is a diagram illustrating an appearance example of the input device 20. A of FIG. 4 illustrates an appearance of the input device 20 when the input device 20 is attached to the palm with a clip 120. Appearance A1 is an appearance diagram when the input device 20 of the type attached with the clip 120 is viewed from a direction of projecting the infrared light pattern. In the example of Appearance A1, the clip 120 is attached to the upper part of a housing including the projector unit 25 and the image capture unit 26. Appearance A2 is an appearance example when the input device 20 of the type attached with the clip 120 is viewed from above. In Appearance A2, the length of the clip 120 is longer than the housing part of the input device 20. However, the length of the clip 120 may be adjusted according to the implementation. Appearance A3 is an appearance example when the input device 20 of the type attached with the clip 120 is viewed from the side.

B of FIG. 4 illustrates an appearance of the input device 20 when the input device 20 is attached to the palm with a belt 130. Appearance B1 is an appearance diagram when the input device 20 of the type attached with the belt 130 is viewed from a direction of projecting the infrared light pattern. In the example of Appearance B1, the belt 130 is attached to the upper part of a housing including the projector unit 25 and the image capture unit 26. Appearance B2 is an appearance example when the input device 20 of the type attached with the belt 130 is viewed from above. Appearance B3 is an appearance example when the input device 20 of the type attached with the belt 130 is viewed from the side.

G1 of FIG. 4 is an attachment example of the input device 20. G1 illustrates an example when the input device 20 of the type attached with the clip 120 is attached. In both of the cases where the input device 20 is attached with the clip 120 and where the input device 20 is attached with the belt 130, the input device 20 is attached such that the infrared light pattern outputted from the projector unit 25 is projected onto the user's finger and an image of infrared light reflected from the finger is captured by the image capture unit 26.

<Method for Specifying Input Signal>

A method for specifying an input signal is described below by dividing the method into an example of a method for specifying a finger position by using an infrared light pattern and for specifying a positional change in the user's finger, and an example of determination processing using the vibration obtained by the measurement unit 31. Note that the example of the specification method and the example of the determination processing described below are examples for helping the understanding, and may be modified according to the implementation.

(A) Specification of Finger Position and Trajectory Using Infrared Light Pattern.

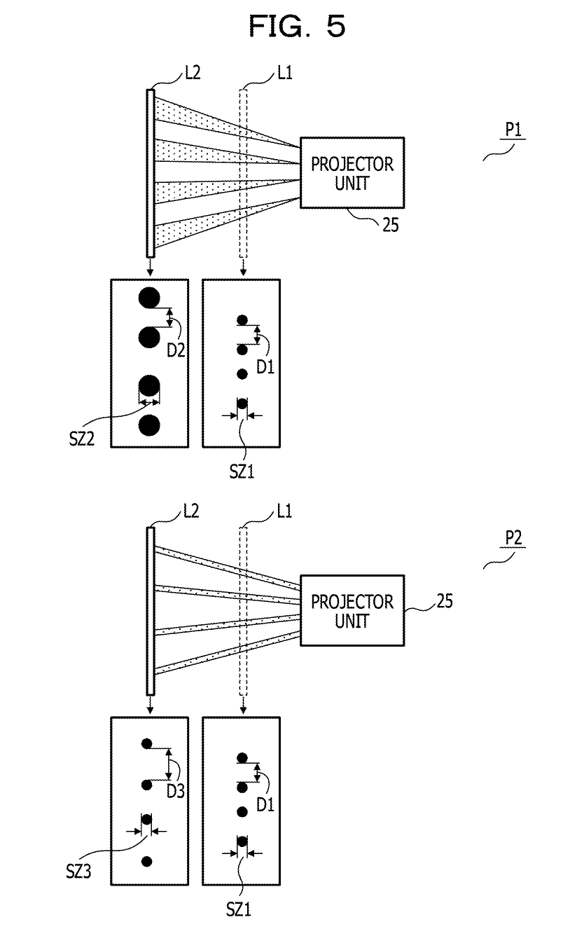

FIG. 5 is a diagram illustrating an example of an infrared light irradiation pattern. In the example of FIG. 5, an infrared light pattern is a dotted pattern. A change in infrared light pattern projected onto the finger varies according to the property of infrared light projected from the projector unit 25 and according to the distance between the projector unit 25 and the user's finger.

Pattern P1 in FIG. 5 illustrates an example of a change in infrared light pattern in the case of use of infrared light of a large diffusion type. It is assumed that, at a position where the distance from the projector unit 25 is L1, the interval between dots of infrared light is D1 and the diameter of each dot is SZ1. In the case of the use of the infrared light of the large diffusion type, the longer the distance between the projector unit 25 and the finger, the larger the dot size. However, the interval between the dots hardly changes. For example, at a position where the distance from the projector unit 25 is L2 longer than L1, the interval between the dots of infrared light is D2 and the diameter of each dot is SZ2. Moreover, the interval D2 between the dots when the distance from the projector unit 25 is L2 is hardly different from the interval D1 between the dots when the distance from the projector unit 25 is L1. On the other hand, the diameter SZ2 of the dot when the distance from the projector unit 25 is L2 is larger than the diameter SZ1 of the dot when the distance from the projector unit 25 is L1.

Pattern P2 in FIG. 5 illustrates an example of a change in infrared light pattern in the case of use of infrared light of a small diffusion type. In the case of the use of the infrared light of the small diffusion type, again, it is assumed that the same irradiation pattern as that in the case of the use of the infrared light of the large diffusion type is obtained when the distance between the projector unit 25 and the finger is L1. In the case of the use of the infrared light of the small diffusion type, the longer the distance between the projector unit 25 and the finger, the larger the interval between the dots. However, the dot size hardly changes. For example, in the case of the use of the infrared light of the small diffusion type, the interval between the dots of infrared light is D3 and the diameter of each dot is SZ3 at a position where the distance from the projector unit 25 is L2. Here, the interval D3 between the dots when the distance from the projector unit 25 is L2 is longer than the interval D1 between the dots when the distance from the projector unit 25 is L1. Meanwhile, the diameter SZ3 of the dot when the distance from the projector unit 25 is L2 is almost the same as the diameter SZ1 of the dot when the distance from the projector unit 25 is L1.

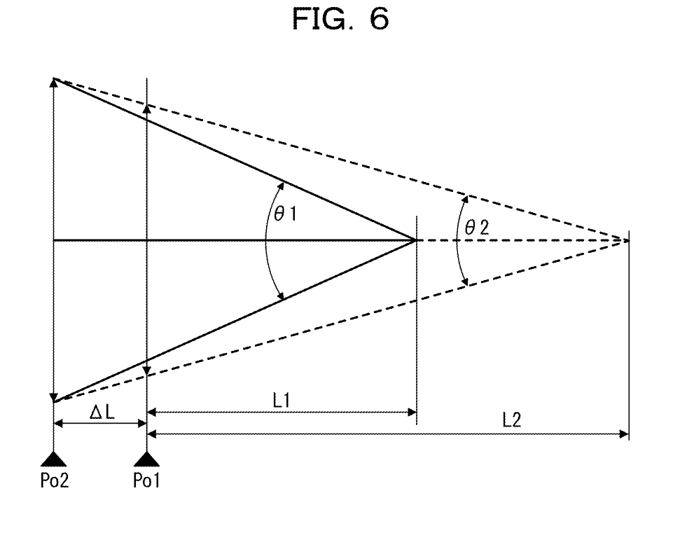

FIG. 6 is a diagram illustrating an example of a method for calculating a change in distance. In FIG. 6, description is given of the case, as an example, of using infrared light with small diffusion. In the example of FIG. 6, it is assumed that an angle of view of a camera included in the image capture unit 26 is θ1 and a pattern irradiation angle is θ2. Moreover, for easier understanding, it is assumed that θ1 is a value as small as may be approximated to tan θ1≈θ1. Likewise, as for θ2, it is assumed that θ2 is a value as small as may be approximated to tan θ2≈θ2. Note that, when no approximation of θ1 and θ2 is performed from a reason such as that θ1 and θ2 are large, correction is performed for an increased difference in interval of the pattern between the center portion and the peripheral portion. However, such correction processing may be performed by any known calculation.

It is assumed that the interval of the irradiation pattern reflected on the finger when the finger is at a position Po1 is D1 and the interval of the irradiation pattern at a position Pot is D2. Moreover, it is assumed that the distance between the position Po1 and the image capture unit 26 is L1 and the distance between the position Po1 and the projector unit 25 is L2. Furthermore, it is assumed that the distance between the positions Po1 and Pot is ΔL. Then, the relationship represented by Equation (1) is established.

D2/D1=(L2+ΔL)/L2 (1)

Next, it is assumed that the interval of the pattern image-captured by the image capture unit 26 when the finger is at the position Po1 is d1 and the interval of the pattern image-captured by the image capture unit 26 at the position Pot is d2. Then, as for d1 and d2, Equation (2) is established.

d2/d1=L1/(L1+ΔL)×(L2+ΔL)/L2 (2)

Equation (3) is obtained when Equation (2) is solved in terms of ΔL.

ΔL=(d1−d2)/{(d2/L1)−(d1/L2)} (3)

Here, L1 and L2 are obtained from measurement when the user's finger is located at Po1. Moreover, d1 and d2 are obtained by analysis processing on an image obtained by the image capture unit 26. Thus, the generation unit 32 may obtain ΔL by using Equation (3).

On the other hand, in the case of use of infrared light with large diffusion, the position of each finger is specified by using the fact that the size of the dot obtained by diffusion is increased proportional to the distance from the input device 20. A calculation method used in this event is any known calculation method.

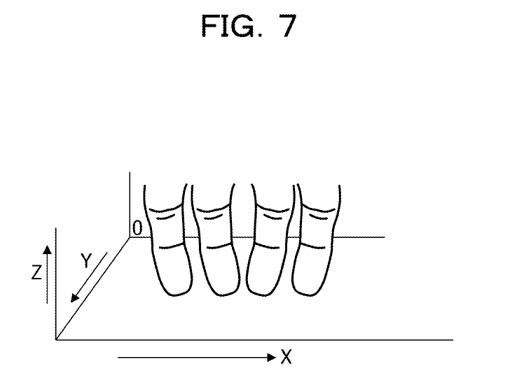

FIG. 7 is a diagram illustrating an example of coordinates. In the following description, as illustrated in FIG. 7, a Z-axis represents information in a height direction, and XYZ coordinates with the origin of an XY plane at the upper left corner are used. Moreover, the value of a Y-axis is a function of the distance from the image capture unit 26 obtained by analysis of the image-captured pattern. The shorter the distance from the image capture unit 26, the larger the value. Thus, the closer to the input device 20 the position, the larger the value of the Y-axis. Moreover, the image captured by the image capture unit 26 is an image on the XZ plane.

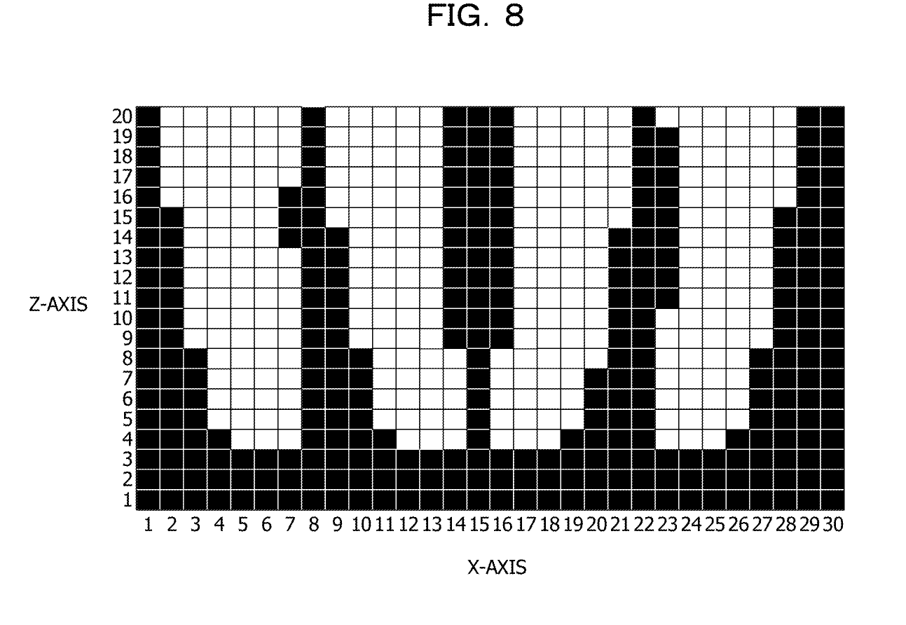

FIG. 8 is a diagram illustrating an example of a method for detecting positions of fingers. FIG. 8 illustrates an example of an analysis result obtained by the generation unit 32 analyzing the image captured by the image capture unit 26. The generation unit 32 calculates the average of the values of the Y-axis (values in a depth direction) in a square area for each of squares obtained by dividing the captured image with every change in the values of X-axis and Z-axis at the coordinates described with reference to FIG. 7. More specifically, for each square area, the position of the image-captured target from the camera is obtained as the value of the Y-axis. Moreover, the closer the image-captured target is to the image capture unit 26, the shorter the distance from the image capture unit 26. Thus, the value associated with the area is increased. The generation unit 32 specifies an area having a relatively large Y-axis value as the position where the finger is located. In FIG. 8, the positions indicated by white squares are regions where the Y-axis values exceed a predetermined threshold, and thus are positions where the user's fingers are supposed to be located. Meanwhile, the black squares in FIG. 8 are positions with relatively small Y-axis values, since no infrared light is reflected because of absence of fingers, and the amount of reflected light image-captured by the image capture unit 26 is small. Therefore, the fingers are detected in the regions indicated by the white squares in FIG. 8.

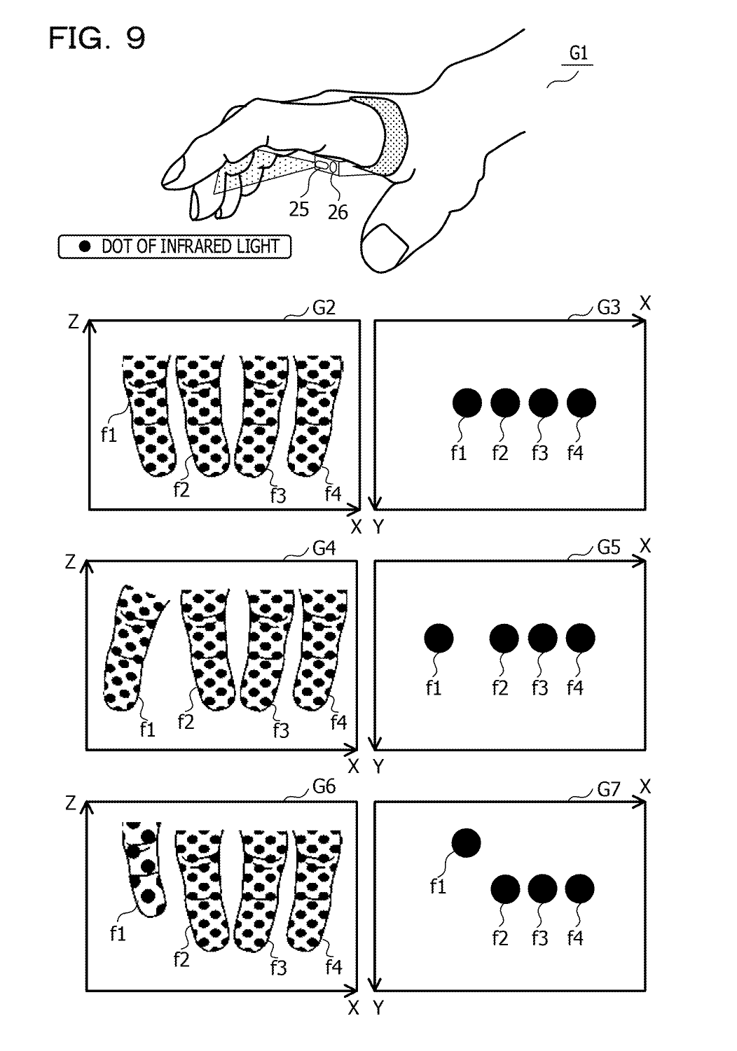

FIG. 9 is a diagram illustrating an example of a method for detecting the positions of the fingers. With reference to FIG. 9, description is given of a relationship between detected positions of the fingers and patterns projected onto the fingers. Note that, for easier understanding, G1 of FIG. 9 illustrates an attachment example of the input device 20 and an example of the positional relationship between the fingers. G2 of FIG. 9 illustrates an example when the positions of the fingers specified by analysis of the data obtained in FIG. 8 are specified on the XZ plane. Note that the black circles in G2 represent how the infrared light patterns are projected. One of the black circles corresponds to one of the dots in the infrared light pattern. The generation unit 32 associates an identifier with the detected finger. In the following example, it is assumed that the generation unit 32 associates identifiers f1, f2, f3, and f4 with the detected fingers in ascending order of X-coordinate of the detected finger. In the example of FIG. 9, f1 corresponds to an index finger, f2 corresponds to a middle finger, f3 corresponds to a fourth finger, and f4 corresponds to a fifth finger. G3 illustrates a result in which the analysis results of the positions of the tips of the respective fingers located when the image of G2 is obtained are represented as positions on the XY plane with the origin at the upper left corner. The position of each of the fingers obtained in G2 and G3 may be hereinafter described as the “home position”.

G4 illustrates an example of an image on the XZ plane captured by the image capture unit 26 when the user extends his/her index finger f1 to the left. The data obtained by the image capture unit 26 is obtained as Y-coordinate values at each coordinate within the XY plane as illustrated in FIG. 8. However, in G4, to facilitate visualization, the shapes of the fingers specified by the generation unit 32 are represented by recognizing the regions where the Y-axis values are not less than a predetermined region as the positions where the fingers are located. Moreover, in G4, the regions where the intensity of the infrared light pattern used by the generation unit 32 to specify the shapes of the fingers is relatively strong are represented by the dots of infrared light, thus illustrating how the infrared light pattern is projected onto the user's fingers.

In the example of G4, the size of the dots of infrared light projected onto the index finger f1 and the interval between the dots are almost the same as those of the other fingers. Thus, the generation unit 32 determines that, even though the leftmost finger (index finger f1) among the four fingers onto which the infrared light is projected is at almost the same distance as the other fingers, the position thereof is shifted to the left. Therefore, using the image illustrated in G4, the generation unit 32 determines that the tips of the user's four fingers are positioned as illustrated in G5 when represented on the XY plane. In G5, while the tip of the index finger f1 is positioned to the left of the home position, the middle finger f2, the fourth finger f3, and the fifth finger f4 are at the home positions.

G6 illustrates an analysis example of an image on the XZ plane captured by the image capture unit 26 when the user extends his/her index finger f1 from the home position in a direction away from the input device 20. In G6, again, to facilitate visualization, the shapes of the fingers specified by the generation unit 32 and how the infrared light pattern is projected are illustrated as in the case of G4. In the example of G6, the size of the dots of infrared light projected onto the index finger f1 is larger than that of the dots projected onto the other fingers. Therefore, the generation unit 32 determines that the leftmost finger (index finger f1) among the four fingers onto which the infrared light is projected is located at a position farther away from the input device 20 than the other fingers. Moreover, as illustrated in G6, the positions of the fingers in the X-axis direction (horizontal direction) of the shapes of the fingers obtained on the XZ plane are not very different from the home positions. Therefore, the generation unit 32 determines, based on the information indicated in G6, that the leftmost finger is extended in a direction opposite to the input device 20, and the other three fingers are at the home positions. Moreover, the generation unit 32 calculates the distance of each of the fingers from the image capture unit 26 by using the size of the dots on each finger, and thus specifies the position of each finger on the XY plane. As a result of the processing by the generation unit 32, it is determined that the tips of the user's four fingers are positioned as illustrated in G7 when represented on the XY plane. More specifically, it is determined that, while the tip of the index finger f1 is at the position farther away from the input device 20 than the home position and not different from the home position in the horizontal direction, the middle finger f2, the fourth finger f3, and the fifth finger f4 are at the home positions. Note that, in G7, it is assumed that the larger the Y-axis value, the closer to the input device 20.

By the processing described above with reference to FIGS. 5 to 9, the input device 20 specifies the positions of the user's fingers. Moreover, the generation unit 32 may also generate the trajectory of the positions of the user's fingers by associating the positions of the user's fingers with time information. In this event, the generation unit 32 may also associate the positions of the user's fingers with the identifiers of the user's fingers, thereby specifying the trajectory obtained by each of the fingers for each of the identifiers of the fingers. The trajectory information generated by the generation unit 32 is stored in the storage unit 40 as appropriate. A specific example of processing using the trajectory of the positions of the user's fingers is described later.

(B) Determination Processing Using Result of Vibration Measurement by Measurement Unit 31

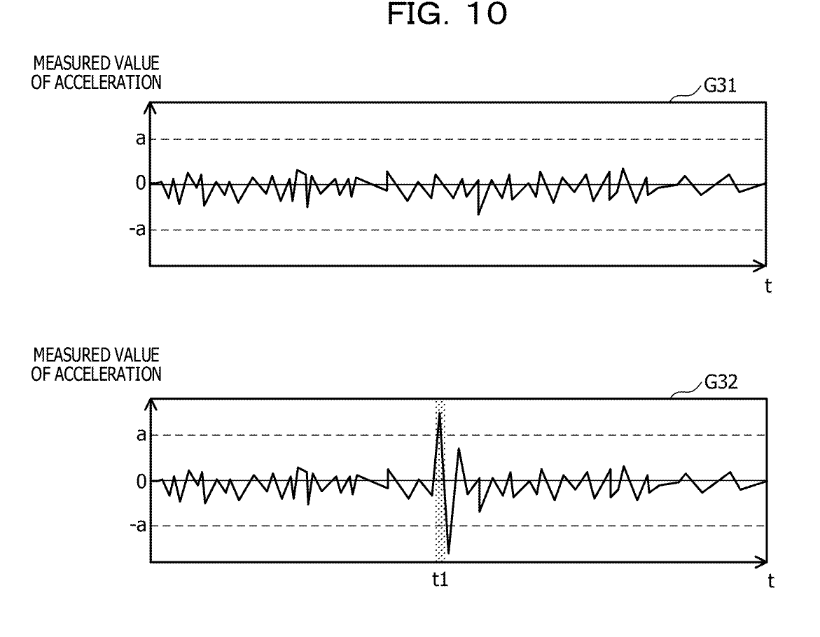

FIG. 10 is a diagram illustrating an example of an acceleration measurement result. G31 of FIG. 10 is an example of a temporal change in the acceleration observed by the measurement unit 31. In G31, the vertical axis represents the acceleration, and the horizontal axis represents time. The measurement unit 31 outputs the measurement result of the acceleration to the generation unit 32. When the absolute value of the observed acceleration exceeds a threshold a, the generation unit 32 determines that a vibration when a tap operation is performed by the user is observed. More specifically, when the measured acceleration exceeds a or is smaller than −a, the generation unit 32 determines that the vibration associated with the tap operation is detected. In the example of G31 in FIG. 10, since the absolute value of the acceleration does not exceed the threshold a, the generation unit 32 determines that no tap operation is performed. On the other hand, in G32 of FIG. 10, since the absolute value of the measured value of the acceleration at a time t1 exceeds the threshold a, the generation unit 32 determines that the tap operation is performed by the user at the time t1.

### OPERATION EXAMPLES

Hereinafter, description is given of examples of input processing from the input device 20 and operations of the terminal 10, which are performed using the method for specifying an input signal according to the embodiment. Note that, in the following examples, description is given of the case, as an example, where an infrared light pattern using infrared light with relatively large diffusion is projected onto the user's finger. However, infrared light with small diffusion may be projected.

### First Operation Example

In a first operation example, description is given of an example of processing when each of selectable regions is associated with the finger detected by the input device 20 on a screen displaying an image including the selectable regions.

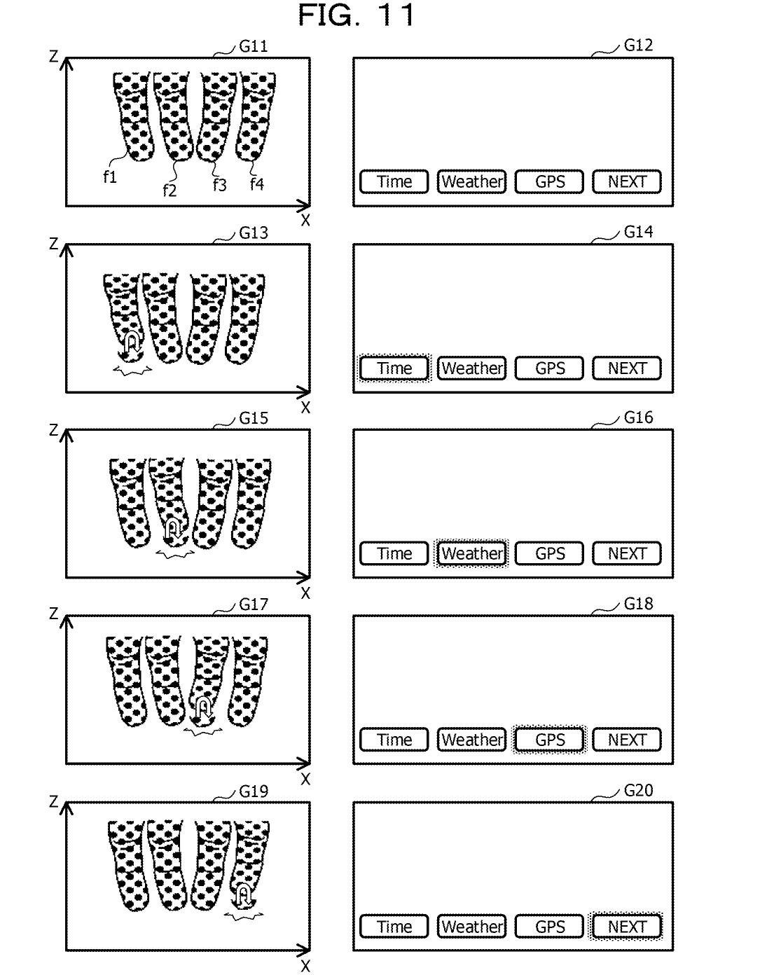

FIG. 11 is a diagram illustrating an example of input processing according to the first operation example. G11 of FIG. 11 is an example of an irradiation pattern when the user's fingers are at the home positions. In G11, the user's four fingers are detected. Moreover, the generation unit 32 associates the identifiers with the detected fingers, respectively. The input device 20 notifies the terminal 10 of the identifiers associated with the detected fingers, respectively. In the example of FIG. 11, it is assumed that the generation unit 32 notifies the terminal 10 through the transmission unit 22 that the identifiers of the fingers are f1 to f4.

It is assumed that the terminal 10 displays an image illustrated in G12 of FIG. 11 on a screen of a display. In the image illustrated in G12, four selectable regions, Time button, Weather button, GPS button, and NEXT button, are displayed. The terminal 10 assigns one of displayable regions to each of the identifiers of the fingers notified from the input device 20. The terminal 10 may use any method to associate each of the detected fingers with each of the identifiers of the selectable regions. In FIG. 11, it is assumed that Time button is associated with the finger f1, Weather button is associated with the finger f2, GPS button is associated with the finger f3, and NEXT button is associated with the finger f4. Meanwhile, the user operates the input device 20 as appropriate according to a change in display on the display of the terminal 10.

G13 of FIG. 11 illustrates an example of an image-capture result obtained when the user taps his/her index finger. When the user taps his/her index finger, the generation unit 32 specifies, based on a change in infrared light reflected by the finger f1, that the finger f1 is lifted in a vertical direction (Z-axis direction) and then lowered in the vertical direction. Moreover, the generation unit 32 also specifies that the position of the finger f1 in the Y-axis direction and the position thereof in the X-axis direction are not changed. It may be said, from the characteristics of the trajectory of the tap operation, that the tap operation is the input to a specific position on the image displayed on the screen of the terminal 10. Note that, in order to specify such a trajectory, the generation unit 32 uses the data and time information stored in the storage unit 40 as appropriate together with the analysis result of the image acquired from the image capture unit 26. When the amount of movement of the fingers in the obtained trajectory exceeds a predetermined threshold Th1, the generation unit 32 determines that processing by the user may executed. Here, when the length of the trajectory obtained by the movement of the fingers does not exceed the threshold Th1, the generation unit 32 reduces an erroneous operation by determining that the user does not move his/her finger to perform the processing. In other words, when the length of the trajectory obtained by the movement of the fingers does not exceed the threshold Th1, the generation unit 32 determines that no input processing is performed by the user, and does not generate a signal for notifying the terminal 10 of the input operation.

On the other hand, when the amount of movement of the fingers in the obtained trajectory exceeds the predetermined threshold Th1, the generation unit 32 determines whether or not the absolute value of the acceleration measured by the measurement unit 31 at the time when the finger f1 is moved in the Z-axis direction exceeds a threshold Th2. When the absolute value of the acceleration measured by the measurement unit 31 at the time when the finger f1 is moved in the Z-axis direction exceeds the threshold Th2, the generation unit 32 determines that the tap operation is performed with the finger f1.

Upon detection of the tap operation, the generation unit 32 transmits a packet for notifying the identifier of the finger performing the tap operation to the terminal 10. In the example of G13, the finger (index finger) having the smallest X value on the XZ plane among the observed fingers is tapped, and the identifier f1 is associated with the finger. Therefore, the generation unit 32 transmits a packet notifying that the tap operation is performed with the finger f1 to the terminal 10 through the transmission unit 22.

Upon receipt of the packet notifying that the tap operation is performed with the finger f1 from the input device 20, the terminal 10 determines that Time button is selected, since Time button is associated with the finger f1. Therefore, the terminal 10 performs the same processing as that when Time button is selected from the input device included in the terminal 10 itself.

When a tap operation is performed with the other finger, again, the input device 20 notifies the terminal 10 of the identifier of the finger of which tap operation is detected. Thus, the terminal 10 performs the same processing as that when a button associated with the finger of which tap operation is performed is selected. For example, in the case of G15, the generation unit 32 specifies the execution of a tap operation with the finger f2, and notifies the terminal 10 of the execution of the tap operation with the finger f2. The terminal 10 performs processing when Weather button is selected, since Weather button is associated with the finger f2 (G16). Moreover, in the case of G17, the generation unit 32 specifies the execution of a tap operation with the finger f3, and notifies the terminal 10 of the execution of the tap operation with the finger f3. The terminal 10 performs processing when GPS button is selected, since GPS button is associated with the finger f3 (G18). Furthermore, in the case of G19, the generation unit 32 specifies the execution of a tap operation with the finger f4, and notifies the terminal 10 of the execution of the tap operation with the finger f4. The terminal 10 performs processing when NEXT button is selected, since NEXT button is associated with the finger f4 (G20).

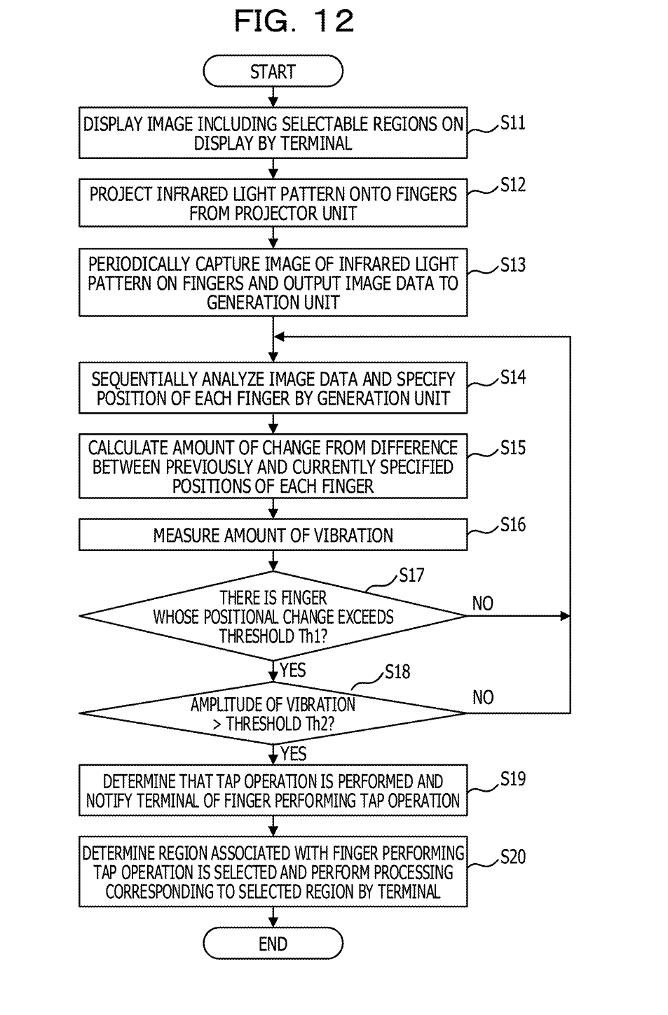

FIG. 12 is a flowchart illustrating an example of the input processing according to the first operation example. FIG. 12 illustrates an example of processing performed after the user's fingers are detected by the generation unit 32. The terminal 10 displays a screen including selectable regions such as icons on the display (Step S11). In this event, the terminal 10 associates each of the selectable regions with each of the detected fingers, since the identifiers of the detected fingers are acquired from the input device 20.

The projector unit 25 projects an infrared light pattern onto the user's finger wearing the input device 20 (Step S12). The image capture unit 26 periodically captures the image of the infrared light pattern reflected on the finger, and outputs the obtained image data to the generation unit 32 (Step S13). The generation unit 32 specifies the position of each finger at the XYZ coordinates by analyzing the image data (Step S14). Note that the “position of each finger at the XYZ coordinates” is a combination of the position of each finger on the XZ plane and the distance in the depth direction. The generation unit 32 calculates the amount of positional change in the finger from a difference between the previous position of each finger at the XYZ coordinates and the position obtained by the analysis (Step S15). The measurement unit 31 measures the amount of vibration (Step S16). The generation unit 32 determines whether or not there is finger whose positional change amount exceeds the threshold Th1 (Step S17). When there is no finger whose positional change amount exceeds the threshold Th1, the processing returns to Step S14 and thereafter (No in Step S17). On the other hand, the positional change amount exceeds the threshold Th1, the generation unit 32 determines whether or not the amplitude of vibration exceeds a threshold Th2 (Yes in Step S17, Step S18). When the amplitude of vibration does not exceed the threshold Th2, the processing returns to Step S14 (No in Step S18).

On the other hand, when the amplitude of vibration exceeds the threshold Th2, the generation unit 32 determines that a tap operation is executed by the finger whose positional change exceeds the threshold Th1, and transmits a packet notifying the finger of which tap operation is executed to the terminal 10 (Yes in Step S18, Step S19). Upon receipt of the packet from the input device 20, the terminal 10 determines that a region associated with the finger of which tap operation is executed is selected, and performs processing corresponding to the determined region (Step S20).

As described above, according to the first operation example, the finger detected by the input device 20 is associated with the region displayed on the display of the terminal 10. Moreover, when notified of the finger whose tap operation is detected, the terminal 10 performs the same processing as that when the region associated with the finger whose tap operation is detected is selected. Thus, the user may easily perform input processing to the terminal 10.

Furthermore, when the length of the trajectory obtained by the movement of the fingers does not exceed the predetermined threshold Th1, the input device 20 determines that the position of the user's finger is changed even though such an operation is not intended by the user. Thus, the input device 20 may reduce input processing that is not intended by the user, when the user is using the input device 20 in a crowded place and something hits against the user's hand or when the user intends to perform processing and stops the processing, for example.

Moreover, when the input device 20 is used, the user only has to wear one device, as described with reference to FIG. 4 and the like, to specify the positions of the fingers. Thus, user-friendliness is also improved.

### Second Operation Example

In a second operation example, description is given of an example of processing when each of selectable regions is not associated with the finger detected by the input device 20 on the screen displaying an image including the selectable regions.

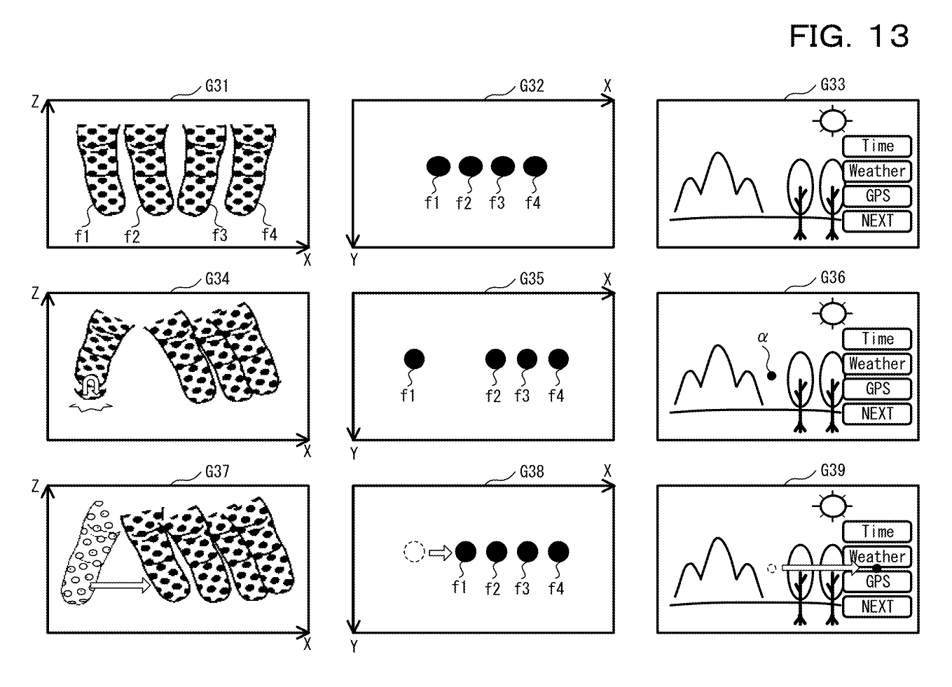

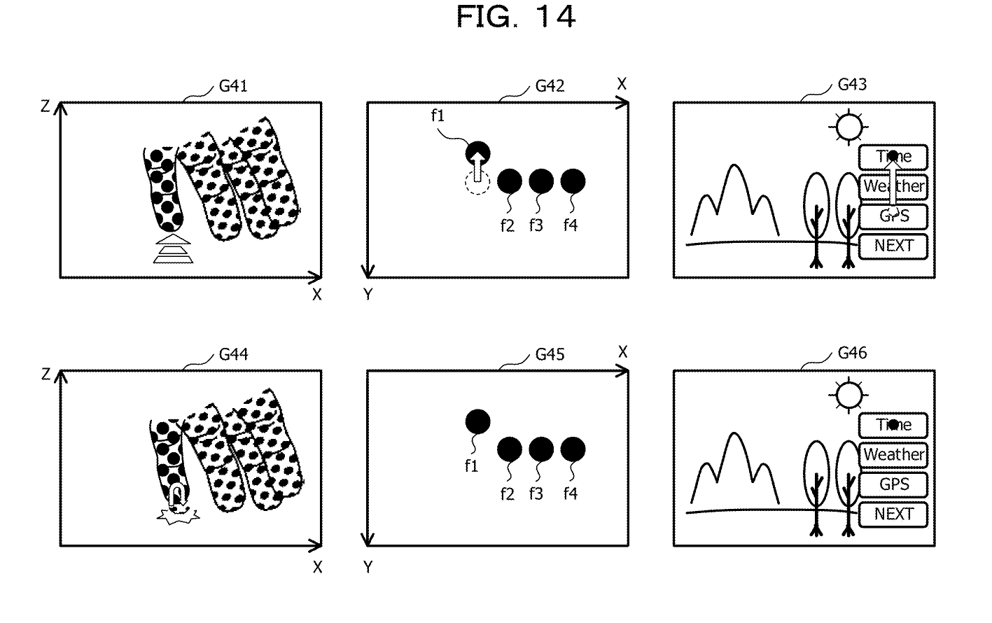

FIGS. 13 and 14 are diagrams illustrating an example of input processing according to the second operation example. G31 illustrates an example of the positions of the user's fingers at the home positions on the XZ plane and the infrared light pattern reflected on the user's fingers. Also, G32 illustrates the positions of the tips of the fingers on the XY plane when the user's fingers are at the home positions. Moreover, G33 illustrates an example of an image displayed on the terminal 10 when the second operation example is performed. It is assumed that Time button, Weather button, GPS button, and NEXT button are also displayed in the image illustrated in G33.

Thereafter, it is assumed that, as illustrated in G34, the user performs a tap operation with his/her index finger. Then, the execution of the tap operation with the user's finger f1 is detected, using the same method as that described in the first operation example, by the processing by the projector unit 25, the image capture unit 26, and the generation unit 32. G35 illustrates the positions of the user's fingers f1 to f4 on the XY plane when the tap operation is executed. In the infrared light pattern illustrated in G34, the size of the dots does not significantly vary with the finger. Thus, the generation unit 32 determines, as illustrated in G35, that the distances of the fingers f1 to f4 from the image capture unit 26 are almost the same. The generation unit 32 transmits the execution of the tap operation with the finger f1, the identifier of the finger whose tap operation is executed, and the coordinates of the execution of the tap operation to the terminal 10.

When notified of the execution of the tap operation with one finger from the input device 20, the terminal 10 displays a pointer α at a predetermined position on the screen. In the example of FIG. 13, it is assumed that, as illustrated in G36, the terminal 10 displays the pointer in the center of the screen when the tap operation is detected. The terminal 10 stores the coordinates notified from the input device 20.

G37 is an example of the positions of the user's fingers on the XZ plane and the infrared light pattern reflected on the user's fingers when the user moves his/her index finger to the right after the processing of G34. G38 illustrates the positions of the user's fingers f1 to f4 on the XY plane when the user moves his/her index finger to the right. When the infrared light pattern illustrated in G37 is obtained, it is assumed that the measurement unit 31 does not observe vibration in which the absolute value of acceleration exceeds the threshold a. Then, the generation unit 32 recognizes that the finger f1 slides as illustrated in G35 to G38, and notifies the terminal 10 of the coordinates at which the finger f1 is positioned after the movement. Note that the generation unit 32 may periodically notify the terminal 10 of the coordinates of the finger f1 during the movement of the finger f1. Hereinafter, the operation when the finger slides as illustrated in G37 may be described as a swipe operation. It may be said, from the characteristics of the trajectory of the swipe operation, that the swipe operation is input involving a positional change on the image displayed on the screen of the terminal 10.

Upon receipt of a change in the coordinates of the finger f1 from the input device 20, the terminal 10 obtains the trajectory of the positional change in the finger f1. Furthermore, the terminal 10 moves the pointer α based on the trajectory obtained by the input device 20. Here, the trajectory of the pointer α is calculated as the trajectory at the coordinates used for display on the screen of the terminal 10 by multiplying the trajectory of the finger f1 notified from the input device 20 by a preset multiplying factor. G39 illustrates an example of the movement of the pointer α.

G41 of FIG. 14 is an example of the positions of the user's fingers on the XZ plane and the infrared light pattern reflected on the user's fingers when the user moves his/her index finger in a direction in which the Y-axis value is reduced after the processing of G37. Note that, in FIG. 14, the direction in which the Y-axis value is reduced is a direction in which the user's finger moves away from the wrist. In the infrared light pattern illustrated in G41, the size of the dots on the finger f1 is larger than that of the dots on the fingers f2 to f4. Thus, the generation unit 32 determines that the finger f1 is at the position farther away from the image capture unit 26 than the other fingers, as illustrated in G42. Therefore, the generation unit 32 analyzes the positions of the user's fingers f1 to f4 on the XY plane as illustrated in G42, together with the image-capture result on the XZ plane. Furthermore, it is assumed that, when the infrared light pattern illustrated in G41 is obtained, the measurement unit 31 does not observe vibration in which the absolute value of acceleration exceeds the threshold a. Then, the generation unit 32 recognizes that the finger f1 slides as illustrated in G38 to G41, and notifies the terminal 10 of the coordinates at which the finger f1 is positioned.

Upon receipt of a change in the coordinates of the tip of the finger f1 from the input device 20, the terminal 10 obtains the trajectory of the pointer α from the trajectory of the change in the coordinates of the finger f1 by performing the same processing as that described taking G39 as an example. The terminal 10 changes the position of the pointer α along the obtained trajectory. Thus, as illustrated in G43, the pointer α moves on the screen.

Thereafter, it is assumed that the user performs a tap operation with his/her index finger. As described with reference to G34, the execution of the tap operation with the user's finger f1 is detected. Moreover, in this case, the positions of the respective fingers when the tap operation is performed are not changed from those described with reference to G41. Thus, the infrared light pattern projected onto the user's fingers is as illustrated in G44. G45 illustrates the positions of the user's fingers f1 to f4 on the XY plane when the tap operation is executed. The generation unit 32 transmits the execution of the tap operation with the finger f1, the identifier of the finger whose tap operation is executed, and the coordinates of the execution of the tap operation to the terminal 10.

Upon receipt of the execution of the tap operation with the finger f1 from the input device 20, the terminal 10 determines whether or not the position of the pointer α overlaps with the selectable region on the screen. In FIG. 14, it is assumed that the position of the pointer α overlaps with the selectable region on the screen, as illustrated in G46. Then, the terminal 10 determines that the region overlapping with the pointer α is selected by the user, and performs the processing.

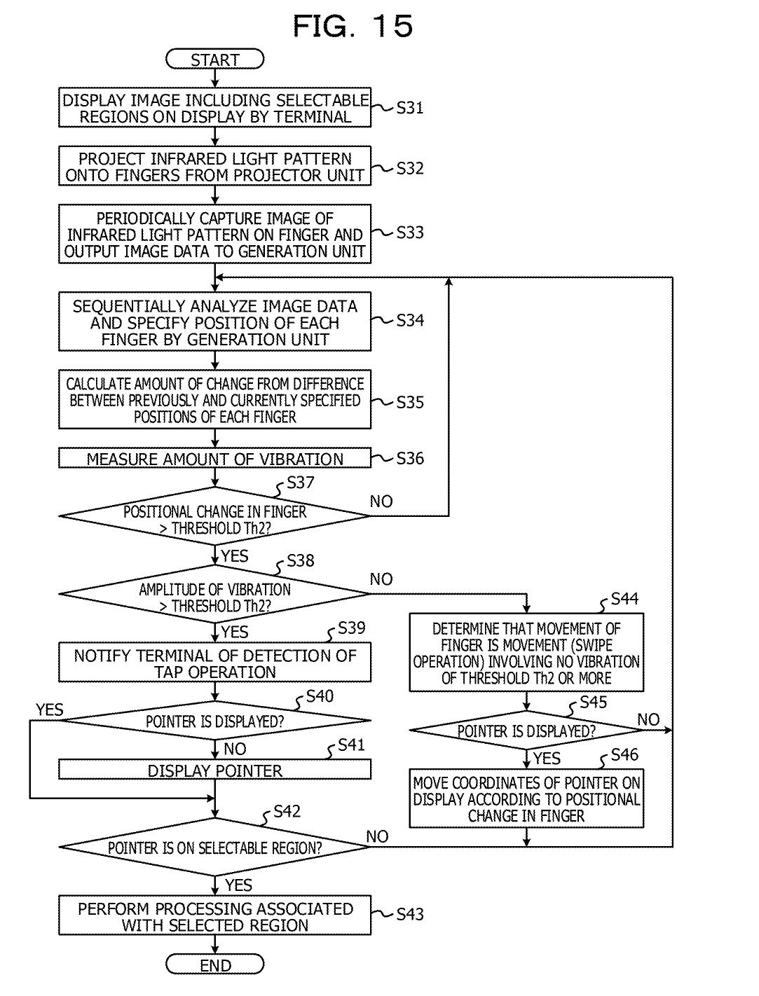

FIG. 15 is a flowchart illustrating an example of the input processing according to the second operation example. In the example of FIG. 15, for easier understanding, description is given of the case, as an example, where a tap operation with one finger or movement of the position of the finger is performed as described with reference to FIGS. 13 and 14.

The terminal 10 displays a screen including selectable regions such as icons on the display (Step S31). The processing of Steps S32 to S36 is the same as that of Steps S12 to S16 described with reference to FIG. 12. The generation unit 32 determines whether or not the amount of positional change in the finger performing the processing exceeds the threshold Th1 (Step S37). When the amount of positional change in the finger performing the processing does not exceed the threshold Th1, the processing returns to Step S34 (No in Step S37). When the amount of positional change in the finger performing the processing exceeds the threshold Th1, the generation unit 32 determines whether or not the amplitude of vibration exceeds the threshold Th2 (Step S38). When the amplitude of vibration exceeds the threshold Th2, the generation unit 32 determines that a tap operation is executed and notifies the terminal 10 to that effect (Yes in Step S38, Step S39).

Upon receipt of a packet notifying the execution of the tap operation from the input device 20, the terminal 10 determines whether or not a pointer is being displayed on the screen (Step S40). When the pointer is not displayed on the screen, the terminal 10 displays the pointer on the screen (No in Step S40, Step S41). Thereafter, the terminal 10 determines whether or not the position of the pointer overlaps with the selectable region (Step S42). When the position of the pointer does not overlap with the selectable region, the processing of Step S34 and thereafter is repeated (No in Step S42). When the position of the pointer overlaps with the selectable region, the terminal 10 determines that the region displayed at the position overlapping with the pointer is selected, and performs processing associated with the region determined to be selected (Step S43).

When the amplitude of vibration does not exceed the threshold Th2 in Step S38, the generation unit 32 determines that a swipe operation is performed (No in Step S38, Step S44). The generation unit 32 notifies the terminal 10 of the execution of the swipe operation together with the position of the finger where the operation is observed. The terminal 10 determines whether or not a pointer is being displayed (Step S45). When the pointer is not displayed, the terminal 10 determines that no operation to the terminal 10 is started by the user, and the processing of Step S34 and thereafter is repeated (No in Step S45). When the pointer is displayed on the screen, the terminal 10 moves the coordinates at which the pointer is displayed on the screen, according to the positional change in the finger (Yes in Step S45, Step S46).

As described above, according to the second operation example, the user may select the selectable region on the screen even though the finger detected by the input device 20 is not associated with the region displayed on the screen of the terminal 10. Moreover, the user may easily perform input processing to the terminal 10. Moreover, in the second operation example, again, it is determined that no input processing is performed when the trajectory obtained by the movement of the user's finger does not exceed the predetermined threshold Th1, as in the case of the first operation example. Thus, input processing not intended by the user attributable to a positional shift in the user's finger and the like may be reduced.

### Third Operation Example

In a third operation example, description is given of an example of processing when the display of the screen is increased or reduced (pinched out or pinched in) on the screen displaying an image. In the third operation example, description is given of the case where, in order to reduce erroneous operations, an increase or reduction processing is performed when an operation is normally performed with a finger stored by the input device 20 as the finger to be used by the user to increase or reduce the display of the screen. Note that, in the third operation example, again, the identifier of the finger observed by the input device 20 is represented as a combination of the alphabet f and the number of the observed finger. Moreover, the number included in the identifier of the finger is generated such that the finger having a smaller average of X coordinates among the fingers observed is associated with a smaller value.

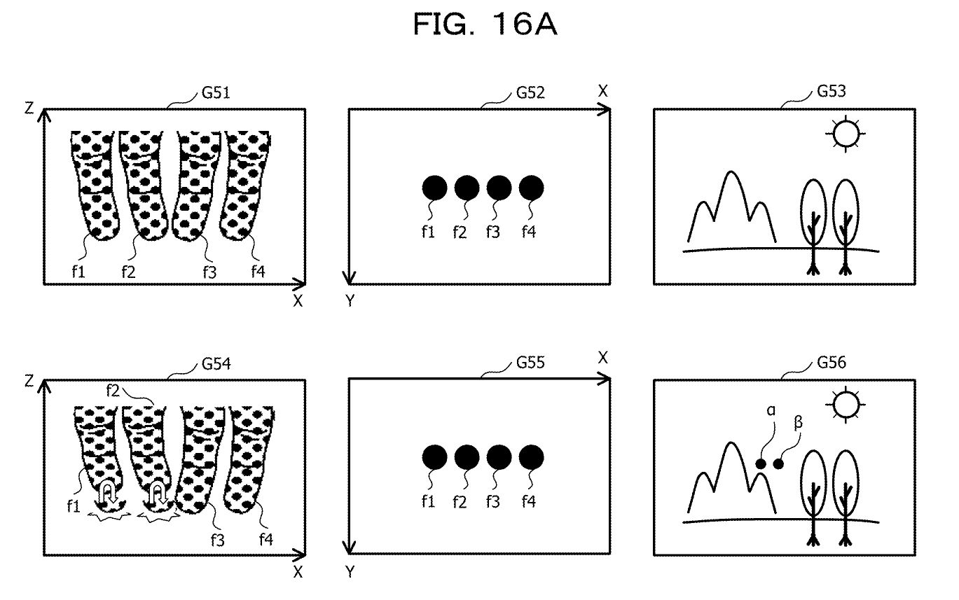

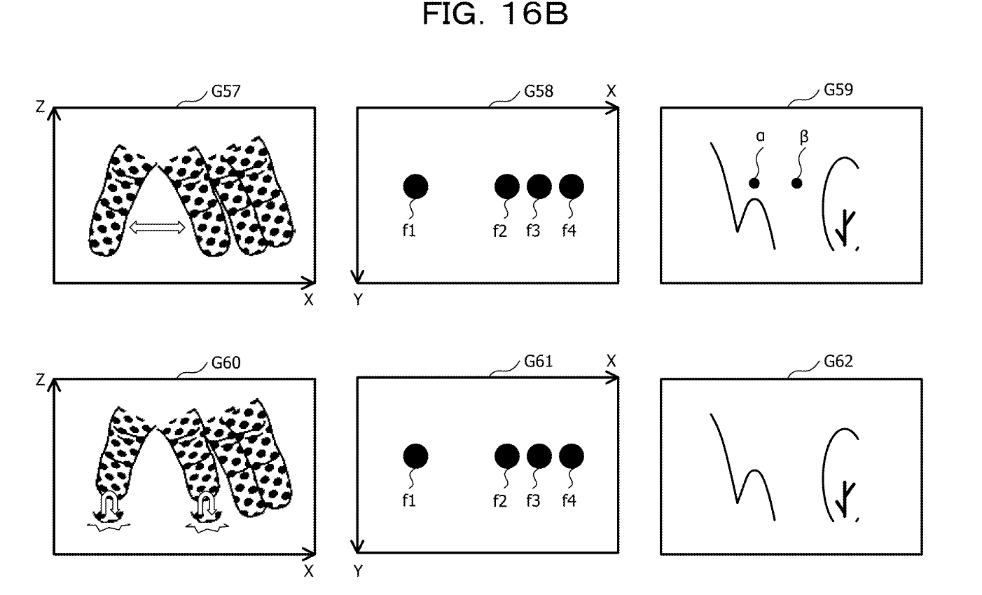

FIGS. 16A and 16B are diagrams illustrating an example of input processing according to the third operation example. With reference to FIGS. 16A and 16B, description is given of an operation example when editing such as increasing and reducing the screen is associated with the finger f1 and the finger f2. In this case, the input device 20 stores, in the storage unit 40, that the editing such as increasing and reducing the screen is performed with the finger f1 and the finger f2.

G51 of FIG. 16A is an example of the positions of the user's fingers at the home positions on the XZ plane and the infrared light pattern reflected on the user's fingers. G52 illustrates the positions of the tips of the respective fingers on the XY plane when the user's fingers are at the home positions. G53 illustrates an example of an image displayed on the terminal 10 when the third operation example is performed.

Thereafter, it is assumed that the user performs a tap operation with his/her index finger and middle finger, as illustrated in G54. Then, it is specified that a positional change in the Z-axis direction exceeds the threshold Th1 almost simultaneously at the user's fingers f1 and f2, using the same method as that described in the first operation example, by the processing by the projector unit 25, the image capture unit 26, and the generation unit 32. Furthermore, it is assumed that the acceleration whose absolute value exceeds the threshold Th2 is observed by the measurement unit 31 at the time when the positional changes in the user's fingers f1 and f2 are observed. Then, the generation unit 32 determines that the tap operations are performed with the user's fingers f1 and f2. Note that, in the infrared light pattern illustrated in G54, the size of the dots does not significantly vary with the finger. Thus, the generation unit 32 determines that the distances of the fingers f1 to f4 from the image capture unit 26 are almost the same. G55 illustrates a specific example of the positions of the user's fingers f1 to f4 on the XY plane when the tap operations are executed. The generation unit 32 transmits the execution of the tap operations, the identifiers of the fingers whose tap operations are executed, and the coordinates of the execution of the tap operations to the terminal 10. Thus, in the example of G54 and G55, the information of the tap operations executed with the fingers f1 and f2 are notified to the terminal 10.

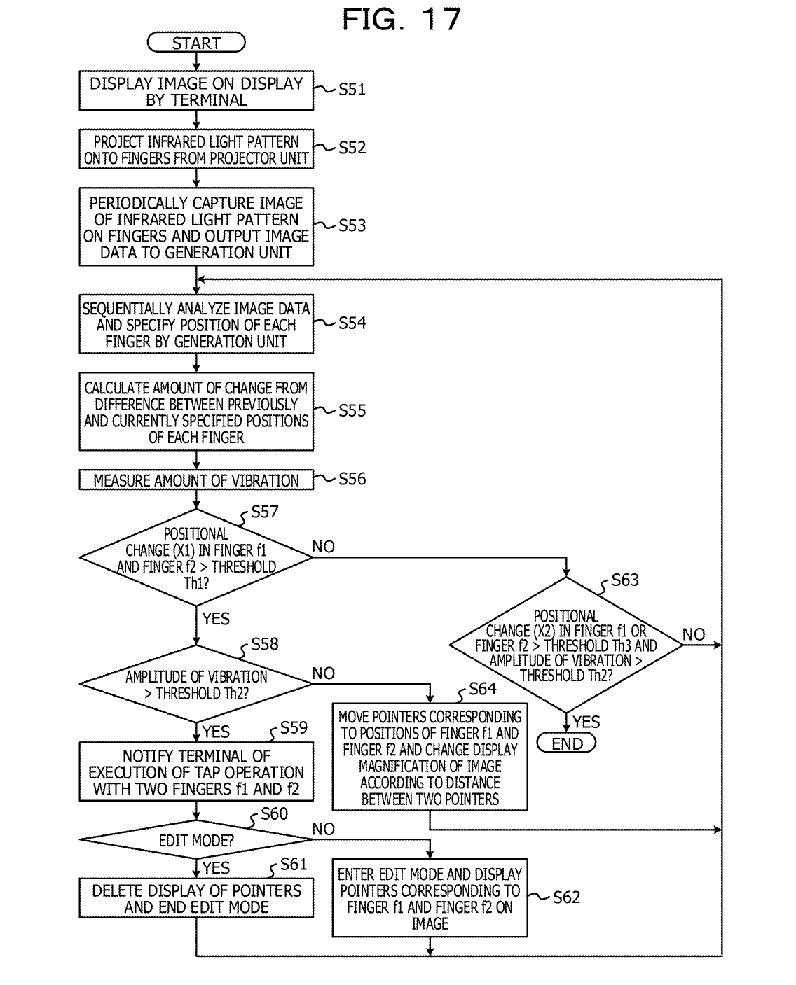

When notified of the execution of the tap operations with the two fingers from the input device 20, the terminal 10 displays a pointer α and a pointer β on the screen as illustrated in G56, and sets the terminal 10 in an edit mode. Note that, in FIGS. 16A to 17, the edit mode is a mode for changing the display magnification of the image that is being displayed on the screen. The positions of the pointers are determined such that the middle point between the two pointers is set at a predetermined position such as the center of the screen. Moreover, the distance between the pointers is determined from the coordinates where the tap operation is performed. In order to calculate the distance between the pointers, the terminal 10 first calculates the distance between the two fingers on the XY coordinates, with which the tap operations are executed, from a difference between the coordinates at which the tap operations are observed. The terminal 10 sets a value obtained by multiplying the distance between the two fingers on the XY coordinates, with which the tap operations are executed, by a preset factor, as the distance between the two pointers on the screen. Furthermore, the terminal 10 stores the coordinates related to the tap operations notified from the input device 20.

G57 of FIG. 16B is an example of the positions of the user's fingers on the XZ plane and the infrared light pattern reflected on the user's fingers when the user moves his/her index finger and middle finger so as to separate the fingers from each other after the processing of G54. G58 illustrates the positions of the user's fingers f1 to f4 on the XY plane when the user moves his/her index finger to the left and moves his/her middle finger to the right. It is assumed that, when the infrared light pattern illustrated in G57 is obtained, the measurement unit 31 does not observe vibration in which the absolute value of acceleration exceeds the threshold a. Then, the generation unit 32 recognizes that the fingers f1 and f2 slide as illustrated in G55 to G58, and notifies the terminal 10 of the coordinates at which the fingers f1 and f2 are positioned.

Upon receipt of changes in the coordinates of the fingers f1 and f2 from the input device 20, the terminal 10 uses the coordinates of the fingers f1 and f2 newly notified from the input device 20 to calculate the distance between the pointers α and β. Then, the terminal 10 changes the distance between the pointers α and β in response to the obtained calculation result, and at the same time, changes the display magnification of the image that is being displayed, according to a change in the distance between the pointers. For example, when notified of the fact that the fingers f1 and f2 are moving away from each other as illustrated in G55 to G58, the terminal 10 increases the display magnification of the image that is being displayed on the screen, with the display positions of the pointers α and β as the center as illustrated in G59.

Thereafter, it is assumed that the user performs tap operations with both of the index finger and the middle finger. The execution of the tap operations with the user's fingers f1 and f2 is detected as described with reference to G51. Moreover, in this case, the positions of the respective fingers when the tap operations are performed are not changed from those described with reference to G57 and G58. Thus, the infrared light pattern projected onto the user's fingers is as illustrated in G60. G61 illustrates the positions of the user's fingers f1 to f4 on the XY plane when the tap operations are executed. The generation unit 32 transmits the execution of the tap operations, the identifiers of the fingers whose tap operations are executed, and the coordinates of the execution of the tap operations to the terminal 10.

When notified of the execution of the tap operations with the fingers f1 and f2 from the input device 20, the terminal 10 determines that the processing of changing the magnification of the displayed image with the pointers α and β is completed. Therefore, the terminal 10 sets the size of the image to that currently displayed. When determining that the size of the display is set, the terminal 10 finishes the edit mode. Furthermore, the terminal 10 finishes the display of the pointers α and β used to change the size of the display. Thus, an image illustrated in G62 is displayed on the screen of the terminal 10.

FIG. 17 is a flowchart illustrating an example of the input processing according to the third operation example. The terminal 10 displays an image on the screen of the display (Step S51). The processing of Steps S52 to S56 is the same as that of Steps S12 to S16 described with reference to FIG. 12. The generation unit 32 determines whether or not the amount of positional change at the XYZ coordinates of the two fingers (fingers f1 and f2) having a smaller X-axis value among the observed fingers exceeds the threshold Th1 (Step S57). In FIG. 17, the threshold Th1 is a value larger than a positional change obtained by a tap operation with one finger. When the positional change (X1) at the XYZ coordinates observed with the fingers f1 and f2 exceeds the threshold Th1, the generation unit 32 determines whether or not the amplitude of vibration exceeds the threshold Th2 (Step S58). When the amplitude of vibration exceeds the threshold Th2, the generation unit 32 determines that tap operations are executed at the fingers f1 and f2, and notifies the terminal 10 to that effect (Yes in Step S58, Step S59).

Upon receipt of a packet notifying the execution of the tap operations from the input device 20, the terminal 10 determines whether or not the edit mode is set (Step S60). When notified of the tap operations with the fingers f1 and f2 from the input device 20 while being set in the edit mode, the terminal 10 finishes the edit mode and finishes the display of the pointers on the screen before returning to Step S54 (Yes in Step S60, Step S61). On the other hand, when notified of the tap operations with the fingers f1 and f2 from the input device 20 while not being set in the edit mode, the terminal 10 enters the edit mode and displays the pointers corresponding to the fingers f1 and f2 on the screen (No in Step S60, Step S62). Thereafter, the processing of Step S54 and thereafter is repeated.

When the input device 20 determines in Step S58 that the amplitude of vibration does not exceed the threshold Th2, the generation unit 32 notifies the terminal 10 of the coordinates of the fingers f1 and f2 (No in Step S58). The terminal 10 uses the packet received from the input device 20 to acquire the coordinates of the fingers f1 and f2. When notified of the coordinates from the input device 20, the terminal 10 in the edit mode moves the pointers according to the notified coordinates, changes the display magnification of the image that is being displayed according to the distance between the pointers, and then returns to Step S54 (No in Step S58, Step S64).

When it is determined in Step S57 that the positional changes at the fingers f1 and f2 do not exceed the threshold Th1, the generation unit 32 determines whether or not the positional change at either of the fingers f1 and f2 exceeds a threshold Th3 and the amplitude of vibration also exceeds the threshold Th2 (Step S63). Here, the threshold Th3 is the magnitude of a positional change obtained by a tap operation with one finger. When the positional change at either of the fingers f1 and f2 exceeds the threshold Th3 and the amplitude of vibration also exceeds the threshold Th2, the input device 20 notifies the terminal 10 of the end of the processing of changing the magnification, and the terminal 10 finishes the edit processing (Yes in Step S63). Note that the fact that the positional change at either of the fingers f1 and f2 exceeds the threshold Th3 and the amplitude of vibration also exceeds the threshold Th2 means that the tap operation is performed with either of the fingers f1 and f2. Therefore, in the flowchart of FIG. 17, the mode of increasing or reducing the image is terminated by the user performing the tap operation with his/her index finger or middle finger. On the other hand, when the condition that the positional change at either of the fingers f1 and f2 exceeds the threshold Th3 and the condition that the amplitude of vibration also exceeds the threshold Th2 are not met, the processing of Step S54 and thereafter is repeated (No in Step S63).

As described above, according to the third operation example, the image displayed on the screen of the terminal 10 is increased or reduced through input from the input device 20. Furthermore, since the finger used to increase or reduce the image is the finger f1 (index finger) or f2 (middle finger), the input device 20 generates no input signal to the terminal 10 even when an operation is performed with any of the other fingers. Therefore, when the processing of the terminal 10 is performed using the input device 20, the display magnification of the image does not change in the terminal 10 even if an operation is performed with the finger other than the index finger and the middle finger. Therefore, the use of the third operation example is likely to reduce erroneous operations. For example, in such a case as where input processing is performed using the input device 20 in a crowded transportation facility, the user's finger may be moved against the user's intention. In such a case, again, operations not intended by the user may be reduced if the finger other than the finger used to increase or reduce the image is moving.

Furthermore, in the example of FIGS. 16A to 17, the description is given of the case, as an example, where the input device 20 is attached to the right hand. However, depending on the dominant hand of the user, the input device 20 may be attached to the left hand. In this case, since the index finger and the middle finger of the dominant hand of the user are fingers having a relatively large X-axis value among the observed fingers. Thus, the method for detecting the finger with the input device 20 may be changed according to the hand on which the input device 20 is attached.

### Fourth Operation Example

In a fourth operation example, description is given of an example of processing when an image displayed on the screen is rotated. In the fourth operation example, description is given of the case where, in order to reduce erroneous operations, rotation processing is performed when an operation is performed with a finger stored in the input device 20 as the finger to be used by the user to rotate the image displayed on the screen. Note that, in the fourth operation example, again, the same identifiers as those in the third operation example are used as the identifiers of the respective fingers. In the following example, it is assumed that the input device 20 stores, in the storage unit 40, that the processing of rotating the image displayed on the screen is performed with the fingers f1 and f2.

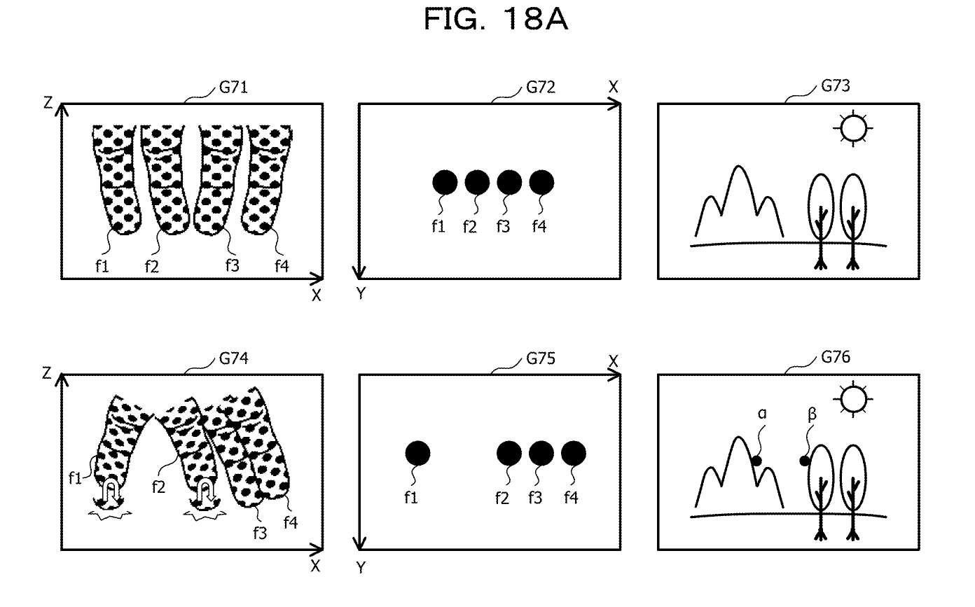

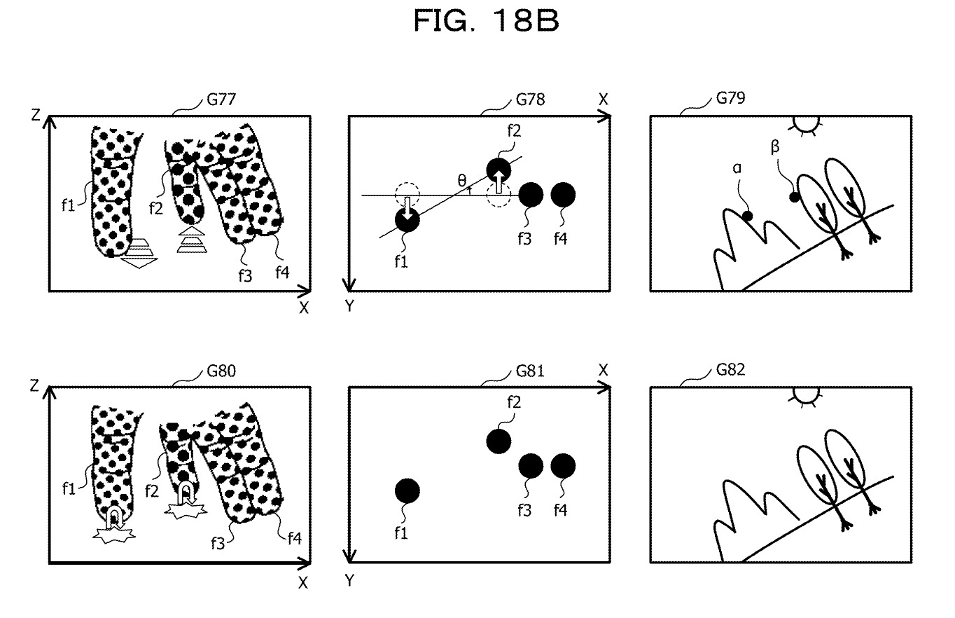

FIGS. 18A and 18B are diagrams illustrating an example of input processing according to the fourth operation example. G71 of FIG. 18A is an example of the positions of the user's fingers at the home positions on the XZ plane and the infrared light pattern reflected on the user's fingers. G72 illustrates the positions of the tips of the respective fingers on the XY plane when the user's fingers are at the home positions. G73 illustrates an example of an image displayed on the terminal 10 when the fourth operation example is performed.

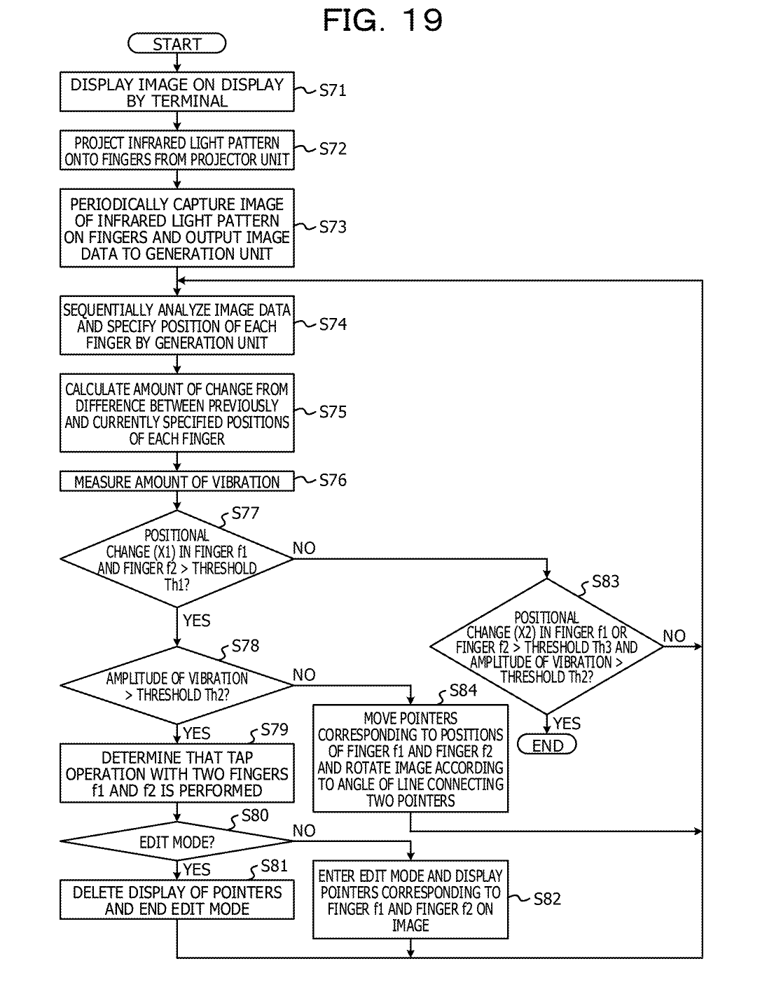

Thereafter, it is assumed that the user performs tap operations with his/her index finger and middle finger, as illustrated in G74. G75 illustrates the positions of the tips of the fingers on the XY plane when the user performs the tap operations as illustrated in G74. The detection of the tap operations by the input device 20 and the notification from the input device 20 to the terminal 10 are the same as the processing described with reference to G54 to G57 of FIG. 16A in the third operation example. As a result, pointers α and β are displayed on the screen of the terminal 10 as illustrated in G76, and the terminal 10 is set in an edit mode. Note that, in FIGS. 18A to 19, the edit mode is a mode for rotating the image that is being displayed on the screen according to the movement of the pointers. Note that the distance between the pointers is determined according to the distance between the two coordinates at which the tap operations are observed. Thus, as illustrated in G76, when the user spreads the space between his/her index finger and middle finger, the distance between the pointers α and β is increased according to the space between the index finger and the middle finger. Therefore, the distance between the pointers is increased in G74 to G76, compared with the case of G54 to G56 of FIG. 16A.

It is assumed that, after the processing of G74, the user moves his/her index finger and middle finger such that a line connecting the index finger and the middle finger before movement intersects with a line connecting the index finger and the middle finger after movement. G77 of FIG. 18B illustrates an example where the user moves his/her middle finger away from the input device 20 and moves his/her index finger close to the input device 20. Then, the dots of the infrared light pattern projected onto the finger f1 of the user are reduced in size compared with the state in G74, while the dots of the infrared light pattern projected onto the finger f2 are increased in size compared with the state in G74. Moreover, the size of the dots of infrared light projected onto the fingers f3 and f4 does not change from that in the state of G74. G78 illustrates the positions of the user's fingers f1 to f4 on the XY plane when the user moves his/her index finger and middle finger as illustrated in G77. In the following description, the angle formed by the line connecting the index finger and the middle finger in the arrangement illustrated in G75 and the line connecting the index finger and the middle finger in the arrangement illustrated in G78 is described as θ. Furthermore, it is assumed that, when the infrared light pattern illustrated in G77 is obtained, the measurement unit 31 does not observe vibration in which the absolute value of acceleration exceeds the threshold a. Then, the generation unit 32 recognizes that the fingers f1 and f2 slide as illustrated in G75 to G78, and notifies the terminal 10 of the coordinates at which the fingers f1 and f2 are positioned.

Upon receipt of changes in the coordinates of the fingers f1 and f2 from the input device 20, the terminal 10 uses the coordinates of the fingers f1 and f2 newly notified from the input device 20 to change the positions of the pointers α and β. Thus, the positions of the pointers α and β change as illustrated in G79. Furthermore, when changing the positions of the pointers α and β, the terminal 10 rotates the displayed image by the angle θ formed by the line connecting the pointers after movement and the line connecting the pointers before movement. The image displayed on the screen at the point of G79 is rotated by θ from the image illustrated in G76.

Thereafter, it is assumed that the user performs tap operations with both of his/her index finger and middle finger. The execution of the tap operations with the user's fingers f1 and f2 is detected as described with reference to G74. Moreover, in this case, it is assumed that the positions of the respective fingers when the tap operations are performed are not changed from those described with reference to G77 and G78. In this case, the infrared light pattern projected onto the user's fingers is as illustrated in G80. G81 illustrates the positions of the user's fingers f1 to f4 on the XY plane when the tap operation is executed. The generation unit 32 transmits the execution of the tap operations, the identifiers of the fingers whose tap operations are executed, and the coordinates of the execution of the tap operations to the terminal 10.

When notified of the execution of the tap operations with the fingers f1 and f2 from the input device 20, the terminal 10 determines that the processing of rotating the displayed image with the pointers α and β is completed. Therefore, the terminal 10 sets the display angle of the image to the current display angle. As it is determined that the display angle is set, the terminal 10 ends the edit mode. Furthermore, the terminal 10 ends the display of the pointers α and β used to change the display angle. As a result, an image illustrated in G82 is displayed on the screen of the terminal 10.

FIG. 19 is a flowchart illustrating an example of the input processing according to the fourth operation example. The processing performed in Steps S71 to S83 is the same as that in Steps S51 to S63 described with reference to FIG. 17. When the input device 20 determines in Step S78 that the amplitude of vibration does not exceed the threshold Th2, the generation unit 32 notifies the terminal 10 of the coordinates of the fingers f1 and f2 (No in Step S78). The terminal 10 uses the packet received from the input device 20 to acquire the coordinates of the fingers f1 and f2. When notified of the coordinates from the input device 20, the terminal 10 in the edit mode moves the pointers according to the notified coordinates. Furthermore, the terminal 10 returns to Step S74 after rotating the displayed image by the angle θ formed by the line connecting the pointers after movement and the line connecting the pointers before movement (Step S84).

As described above, according to the fourth operation example, the image displayed on the screen of the terminal 10 is rotated through input from the input device 20. Furthermore, since the fingers used to perform the rotation are the fingers f1 (index finger) and f2 (middle finger), the input device 20 transmits no input signal to the terminal 10 even when an operation is performed with the other fingers, as in the case of the third operation example. Therefore, the display angle of the image is not changed by the movement of the fingers other than the fingers f1 and f2. Thus, erroneous operations are likely to be reduced. Furthermore, as in the case of the third operation example, the method for detecting the finger with the input device 20 may be changed depending on whether the hand wearing the input device 20 is the right hand or left hand.

### Fifth Operation Example

In a fifth operation example, description is given of an example of processing when the display position of the image displayed on the screen is changed.

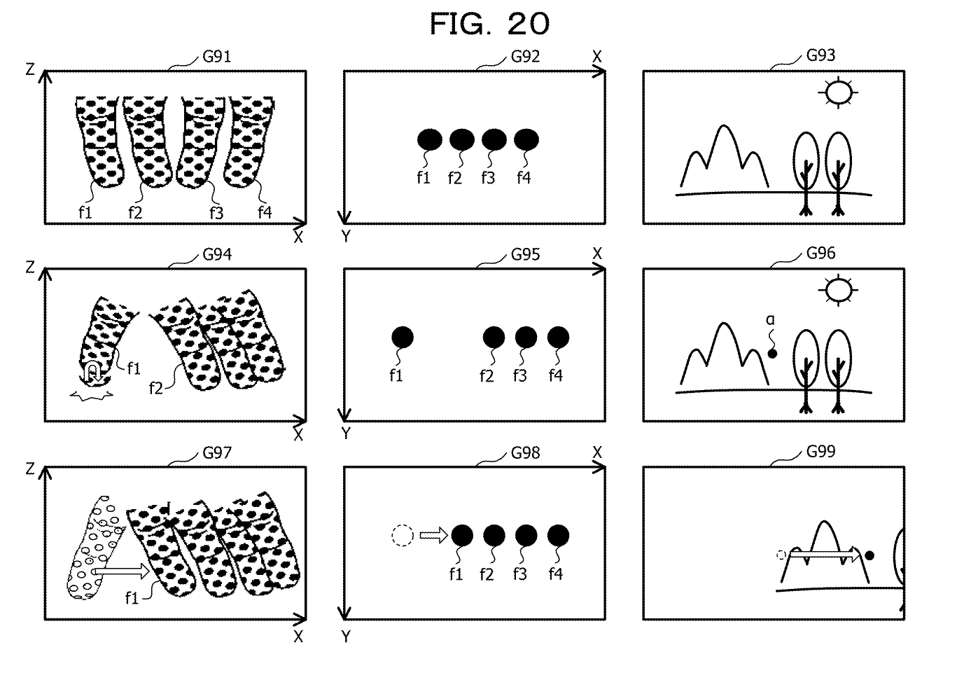

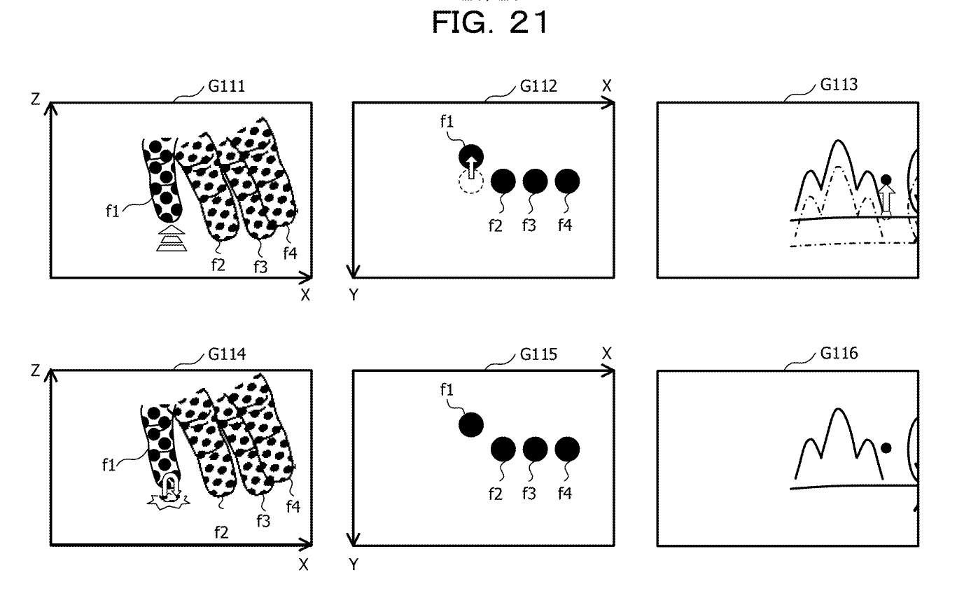

FIGS. 20 and 21 are diagrams illustrating an example of input processing according to the fifth operation example. G91 of FIG. 20 is an example of the positions of the user's fingers at the home positions on the XZ plane and the infrared light pattern reflected on the user's fingers. G92 illustrates the positions of the tips of the respective fingers on the XY plane when the user's fingers are at the home positions. G93 illustrates an example of an image displayed on the terminal 10 when the fifth operation example is performed.

Thereafter, it is assumed that the user performs a tap operation with his/her index finger, as illustrated in G94. Then, the execution of the tap operation with the user's finger f1 is detected, using the same method as that described in the first operation example, by the processing by the projector unit 25, the image capture unit 26, and the generation unit 32. G95 illustrates the positions of the user's fingers f1 to f4 on the XY plane when the tap operation is executed. The generation unit 32 transmits the execution of the tap operation with the finger f1, the identifier of the finger whose tap operation is executed, and the coordinates of the execution of the tap operation to the terminal 10. When notified of the execution of the tap operation with one finger from the input device, the terminal 10 displays a pointer α at a preset position on the screen as illustrated in G96, and shifts to an image scroll mode. Hereinafter, it is assumed that the image scroll mode is a mode for changing the display position of the image. The terminal 10 stores the coordinates notified from the input device 20.

G97 is an example of the positions of the user's fingers on the XZ plane and the infrared light pattern reflected on the user's fingers when the user moves his/her index finger to the right after the processing of G94. G98 illustrates the positions of the user's fingers f1 to f4 on the XY plane when the user moves his/her index finger to the right. Note that it is assumed that, when the infrared light pattern illustrated in G97 is obtained, the measurement unit 31 does not observe vibration in which the absolute value of acceleration exceeds the threshold a. Then, the generation unit 32 recognizes that the finger f1 slides as illustrated in G97, and notifies the terminal 10 of the coordinates at which the finger f1 is positioned.

Upon receipt of a change in the coordinates of the finger f1 from the input device 20, the terminal 10 obtains the trajectory of the positional change in the finger f1. Moreover, the terminal 10 moves the pointer α based on the trajectory obtained by the input device 20. A method for obtaining the trajectory of the pointer α is the same as that in the second operation example. Furthermore, the terminal 10 changes the displayed image itself by the change in display position of the pointer α. Thus, the display position of the image itself is also moved to the right together with the pointer by the processing illustrated in G97 and G98. Thus, the display of the screen changes from G96 to G99.

G111 of FIG. 21 is an example of the positions of the user's fingers on the XZ plane and the infrared light pattern reflected on the user's fingers when the user moves his/her index finger in a direction away from the input device 20 after the processing of G97. Since the user's index finger is away from the input device 20, the dots of the infrared light pattern projected onto the index finger are larger than those projected onto the other fingers. G112 illustrates the positions of the user's fingers f1 to f4 on the XY plane when the user moves his/her index finger in the direction away from the input device 20. It is assumed that, when the infrared light pattern illustrated in G111 is obtained, the measurement unit 31 does not observe vibration in which the absolute value of acceleration exceeds the threshold a. Then, the generation unit 32 recognizes that the finger f1 slides as illustrated in G111, and notifies the terminal 10 of the coordinates at which the finger f1 is positioned.

Upon receipt of a change in the coordinates of the finger f1 from the input device 20, the terminal 10 obtains the trajectory of the positional change in the finger f1. Moreover, the terminal 10 moves the pointer α and the display position of the image based on the trajectory obtained by the input device 20. The processing in this event is the same as that described with reference to G97 to G99. Thus, a screen after the pointer and the image are moved is as illustrated in G113 of FIG. 21.

Thereafter, it is assumed that the user performs a tap operation with his/her index finger. In this case, the execution of the tap operation with the user's finger f1 is detected, as described with reference to G94 (FIG. 20). Moreover, in this case, since the positions of the respective fingers when the tap operation is performed are not changed from those described with reference to G112. Thus, the infrared light pattern projected onto the user's fingers is as illustrated in G114. G115 illustrates the positions of the user's fingers f1 to f4 on the XY plane when the tap operation is executed. The generation unit 32 transmits the execution of the tap operation with the finger f1, the identifier of the finger whose tap operation is executed, and the coordinates of the execution of the tap operation to the terminal 10. When notified of the execution of the tap operation with the finger f1 from the input device 20, the terminal 10 ends the image scroll mode and sets the display position of the image.

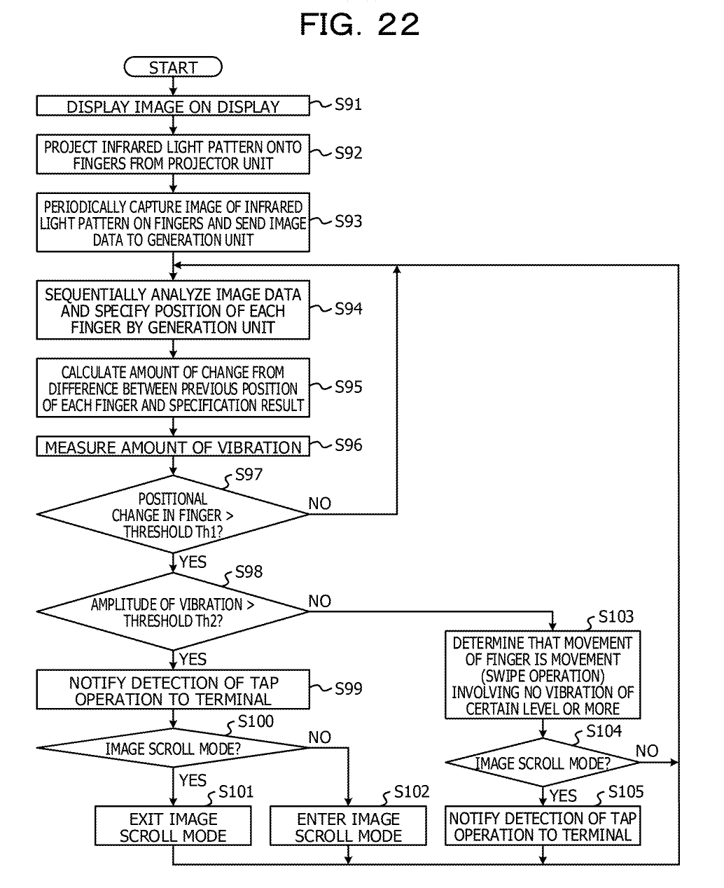

FIG. 22 is a flowchart illustrating an example of the input processing according to the fifth operation example. The terminal 10 displays an image on the screen of the display (Step S91). The processing of Steps S92 to S99 is the same as that of Steps S32 to S39 described with reference to FIG. 15. Upon receipt of a packet notifying the execution of the tap operation from the input device 20, the terminal 10 determines whether or not the image scroll mode is set (Step S100). When not set in the image scroll mode, the terminal 10 shifts to the image scroll mode and returns to Step S94 (No in Step S100, Step S102). On the other hand, when set in the image scroll mode, the terminal 10 ends the image scroll mode and returns to Step S94 (Yes in Step S100, Step S101).

When the amplitude of vibration does not exceed the threshold Th2 in Step S98, the generation unit 32 determines that a swipe operation is performed (Step S103). The generation unit 32 notifies the terminal 10 of the position of the finger where the operation is observed and the execution of the swipe operation. The terminal 10 determines whether or not the terminal is in the image scroll mode (Step S104). When not in the image scroll mode, the terminal 10 determines that the operation is not started, and returns to Step S94 (No in Step S104). When set in the image scroll mode, the terminal 10 moves the display position of the image and the display coordinates of the pointer on the screen according to the positional change in the finger (Yes in Step S104, Step S105).

As described above, according to the fifth operation example, the display position of the image displayed on the screen of the terminal 10 may be easily changed using the input device 20.

### Sixth Operation Example

In a sixth operation example, description is given of an example where the generation unit 32 reduces erroneous operations by using the fact that the pattern of change in the detection position of the finger in the Z-axis direction varies with the shape of the finger in operation.

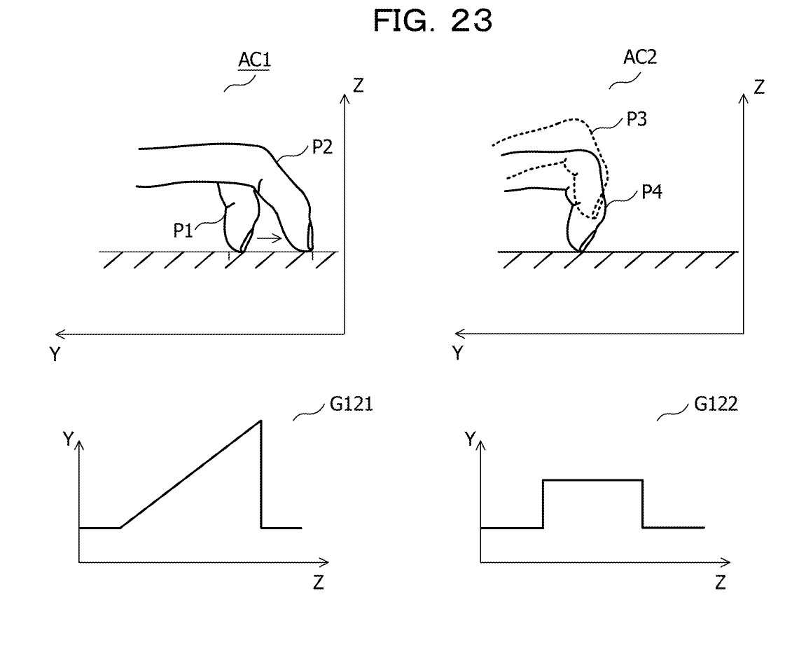

FIG. 23 is a diagram illustrating an example of input processing according to the sixth operation example. AC1 is a diagram illustrating an example of movement when the user slides his/her finger on the YZ plane. For example, when the user slides the finger in a direction in which the Y-axis value is reduced from the shape of the finger indicated by P1, the shape of the finger turns out to be the shape indicated by P2. Here, when the position of the finger is in the state indicated by P1, there is no significant difference in distance of the position where the finger is observed from the input device 20 between the joint of the finger and the finger tip. Therefore, the value of the Y-coordinate at the detection position of the finger does not change significantly even though the height of the spot of the finger to be observed (Z-axis value) changes. Thus, when the distances of the detection positions of the fingers in the Y-axis direction from the image capture unit 26 are plotted with the Y-axis as the vertical axis and the Z-axis as the horizontal axis, a predetermined value is set only in the region where the finger is observed and the Y-axis value is reduced in the region where no finger is observed, as illustrated in G122.

On the other hand, when the position of the finger is in the state indicated by P2, the distance between the position where the finger is observed and the input device 20 is gradually increased from the joint of the finger toward the finger tip. Therefore, the smaller the height of the finger (Z-axis value) to be observed, the smaller the Y-coordinate value at the detection position of the finger. Thus, when changes in the detection position of the finger are plotted with the Y-axis as the vertical axis and the Z-axis as the horizontal axis, the region where the finger is observed is directly proportional to the Z-axis value, as illustrated in G121.

Next, with reference to AC2, description is given of the shape of the finger when a tap operation is performed and a change in Y-coordinate value at the detection position of the finger. When the tap operation is performed, the finger is lifted from a position indicated by P4 to a position indicated by P3, and then returned to the position of P4 again. Thus, from the beginning to the end of the tap operation, there is no significant difference in distance of the position where the finger is observed from the input device 20 between the joint of the finger and the finger tip, as in the case where the position of the finger is at P1. Moreover, with the shape of the finger when the tap operation is performed, the Y-coordinate value at the detection position of the finger does not change significantly even though the height of the spot of the finger to be observed changes. Thus, when changes in the detection position of the finger are plotted with the Y-axis as the vertical axis and the Z-axis as the horizontal axis, G122 is obtained.

Therefore, if a period with a graph having a shape that the Y-axis value is proportional to the Z-axis value as illustrated in G121 is during the operation, when the Y-coordinate values at the detection position of the finger are plotted as the function of the height, the generation unit 32 may determine that the user slides his/her finger.

On the other hand, it is assumed that, when the Y-coordinate values at the detection position of the finger are plotted as the function of the height, the period with the graph having the shape that the Y-axis value is proportional to the Z-axis value as illustrated in G121 is not during the operation, and only the plot illustrated in G122 is obtained. In this case, the generation unit 32 may determine that the user is performing a tap operation.

The sixth determination processing may also be used together with any of the first to fifth operation examples described above. A probability of erroneous operations may be further reduced by combining the processing of determining the type of user operation based on a change in the shape of the user's finger.

For example, the generation unit 32 determines that the tap operation is performed, since the length of the trajectory obtained by the movement of a certain finger exceeds the threshold Th1 and a vibration having an amplitude of a predetermined value or more is generated. In this event, the generation unit 32 further determines whether or not the relationship between the Y-coordinate value and the distance from the finger tip as for the finger determined to be performing the tap operation is as illustrated in G122. When the relationship between the Y-coordinate value and the distance in the height direction from the finger tip as for the finger determined to be performing the tap operation is as illustrated in G122 of FIG. 23, the generation unit 32 determines that the tap operation is performed and outputs an input signal to the terminal 10.

On the other hand, when the relationship between the Y-coordinate value and the distance in the height direction from the finger tip as for the finger determined to be performing the tap operation takes a shape different from that illustrated in G122 of FIG. 23, the generation unit 32 determines that no tap operation is performed. In the case of the shape illustrated in G121 of FIG. 23, for example, it is conceivable that the user is sliding his/her finger. Thus, a tap operation is less likely to be executed. In such a case, since there is a possibility that a user operation is erroneously recognized, the generation unit 32 terminates the processing without generating any input signal.

Likewise, when determining whether or not a swipe operation is performed, again, the generation unit 32 may use the relationship between the Y-coordinate value and the distance in the height direction from the finger tip. For example, the generation unit 32 determines that the swipe operation is performed, since the length of the trajectory obtained by the movement of a certain finger exceeds the threshold Th1, but the vibration having the amplitude of the predetermined value or more is not generated. In this event, the generation unit 32 determines whether or not the relationship between the Y-coordinate value and the distance in the height direction from the finger tip is changed in a gradation pattern according to the distance from the finger tip during a user operation, as illustrated in G121 of FIG. 23. When the Y-coordinate value is changed in the gradation pattern, a state (P2) where the finger is tilted to the input device 20 is generated during the operation, as illustrated in AC1 of FIG. 23. The generation unit 32 determines that the swipe operation is performed.

On the other hand, when the Y-coordinate value is not changed in the gradation pattern, the state where the finger is tilted to the input device 20 is not generated during the operation. Therefore, no swipe operation is performed. Thus, the generation unit 32 determines that there is a possibility that a user operation is erroneously recognized, and thus terminates the processing without generating any input signal.

Note that, in the example of FIG. 23, the description is given of the case where the finger tip performing the swipe operation is moved in the direction away from the input device 20. However, during the swipe operation, the finger tip may be moved in a direction closer to the input device 20. In this case, the relationship between the Y-coordinate value and the distance in the height direction from the finger tip forms a graph that the smaller the Z-axis value, the larger the Y-axis value.

<Others>

The embodiment is not limited to the above, various modifications may be made. Some examples are described below.

For example, when the processor 101 included in the input device 20 has poor performance, the input device 20 may periodically notify the terminal 10 of the result of observation by the measurement unit 31 and a change in coordinate by the generation unit 32, without specifying the type of processing by the user. In this case, the terminal 10 specifies the type of the processing performed by the user, based on information notified from the input device 20.

The terminal 10 configured to acquire an input signal from the input device 20 is not limited to a device of a shape that makes input difficult to perform, such as a wearable terminal and a watch-type terminal. For example, the terminal 10 may be a cell-phone terminal including a smartphone, a tablet, a computer, or the like. When the cell-phone terminal including the smartphone, the tablet, the computer, or the like is used as the terminal 10, there is an advantage that the user may operate the terminal 10 without smearing the surface thereof with skin oil on the finger tip or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An input device that inputs a command to an information processing device, the input device comprising:
a member with which the input device is attached to a hand of a user;
a light source configured to project light onto a finger of the user;
an image capture device configured to capture an image of reflected light from the finger onto which the light is projected; and
a processor configured to:
acquire a plurality of images from the image capture device,
specify a positional change in the finger based on a change in patterns of the reflected light specified from the respective images,
generate the command corresponding to a movement of the finger, based on the positional change, and
input the generated command to the information processing device.

2. An input device comprising:
a projector device configured to project a first light pattern having a predetermined shape onto an object;
an image capture device configured to capture an image of a second light pattern obtained by reflection of the first light pattern on the object; and
a processor configured to:
measure a magnitude of vibration generated by a movement of the object, based on the second light pattern,
specify a trajectory of a positional change in the object by using the second light pattern and the first light pattern,
generate an input signal corresponding to a combination of the trajectory and the magnitude of the vibration, and
transmit the input signal to an input destination device.

3. The input device according to claim 2, wherein the object is a finger of a user.

4. The input device according to claim 2, wherein the processor is configured to:
generate the input signal when a length of the trajectory is longer than a first threshold, and
generate no input signal when the length of the trajectory is not longer than the first threshold.

5. The input device according to claim 4, wherein the processor is configured to:
when the magnitude of vibration during a period in which a trajectory longer than the first threshold is obtained is more than a second threshold, generate first notification information notifying execution of a first operation being input performed on a specific position in an image displayed on a screen included in the device of the input destination, and transmit the input signal containing the first notification information, and
when the magnitude of vibration measured during the period in which the trajectory longer than the first threshold is obtained is not more than the second threshold, generate second notification information notifying execution of a second operation involving a positional change on the image displayed on the screen, and transmit coordinates of a plurality of positions included in the trajectory and the second notification information as the input signal.

6. The input device according to claim 5, further comprising: a memory configured to store information indicating which fingers are to be used for the first and second operations.

7. The input device according to claim 6, wherein the processor is configured to:
when a plurality of fingers are detected from an image captured by the image capture device, specify each of the plurality of fingers by using a detection position of the finger on the captured image,
when the first or second operation is detected, specify a finger used in the detected target operation by using the captured image, and
when the finger used in the target operation is not associated with the target operation, determine that the detected target operation is an erroneous operation.

8. The input device according to claim 7, wherein the processor is configured to stop the generation of the input signal when the target operation is determined to be the erroneous operation.

9. The input device according to claim 6, wherein the memory further stores a shape of each of the fingers performing the first and second operations, the shape being expressed with a distance of a detection position of the finger from the image capture device and a height of the tip of the finger performing the operation.

10. The input device according to claim 9, wherein the processor is configured to:
specify a type of operation being performed by the finger in the captured image, from the shape of the finger detected using the second light pattern detected by the image capture device, and
stop the generation of the input signal when the result of the specification using the detected shape of the finger does not match the result of the specification based on a combination of the trajectory of a positional change in the finger of the user and the magnitude of the vibration.

11. The input device according to claim 2, wherein the processor is configured to:
when a plurality of fingers are detected from an image captured by the image capture device, specify each of the plurality of fingers by using a detection position on the captured image, and
generate the input signal including information identifying the finger performing an operation.

12. The input device according to claim 2, wherein the first light pattern and the second light pattern are infrared light patterns.

13. An input control method executed by a computer, the input method comprising:
projecting a first light pattern having a predetermined shape onto an object;
acquiring an image of a second light pattern obtained by reflection of the first light pattern on the object;
measuring a magnitude of vibration generated by a movement of the object, based on the second light pattern;
specifying a trajectory of a positional change in the object by using the second light pattern and the first light pattern;
generating an input signal corresponding to a combination of the trajectory and the magnitude of the vibration; and
transmitting the input signal to an input destination device.

14. The input control method according to claim 13, wherein the object is a finger of a user.

15. The input control method according to claim 13, wherein the first light pattern and the second light pattern are infrared light patterns.
